(19) United States
(12) Patent Application Publication
(10) Pub. No.: US 2006/0037506 A1
(43) Pub. Date: Feb. 23, 2006

(54) Support for planographic printing plate and planographic printing plate material

(75) Inventor: Hiroshi Takagi, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA MEDICAL & GRAPHIC, INC., Tokyo (JP)

(21) Appl. No.: 11/187,398

(22) Filed: Jul. 22, 2005

(30) Foreign Application Priority Data
Aug. 11, 2004 (JP) JP2004-234204

(51) Int. Cl. B41N 1/00

(52) U.S. Cl. 101/459

(57) ABSTRACT

An object of the invention is to provide a planographic printing plate material exhibiting excellent dot reproduction and printing durability and a support for the planographic printing plate material. Disclosed is a support for a planographic printing plate material having a surface roughened via electrolytic surface-roughening treatment and anodization treatment conducted to one surface of an aluminum plate, wherein a) average surface roughness (Ra) of the roughened surface is 0.30-0.55 μm, and b) the roughened surface possesses a surface profile in which a ratio of Xa/Xb is 0.40-0.70, where Xa is the width expanding to the shallow region side and Xb is the width expanding to the deep region side at the position reaching peak depth in amplitude frequency.

This application claims priority from Japanese Patent Application No. Jp2004-234204 filed on Aug. 11, 2004, which is incorporated hereinto by reference.

### TECHNICAL FIELD

The present invention relates to a planographic printing plate material and an aluminum support used for the planographic printing plate material.

### BACKGROUND

Recently, in a plate-making process of a printing plate for off-set printing, a CTP has been developed in which digital image data can be directly written in a light sensitive planographic printing plate material employing laser, and has been practically used.

Among them, a printing plate material having an aluminum support and provided thereon, an image formation layer are used in printing industries in which a relatively high printing durability is desired.

As the aluminum support, an aluminum plate subjected to surface-roughening treatment and anodization treatment is generally used.

Particularly, the electrolytic surface-roughening has been generally used as a surface-roughening method of an aluminum support for a planographic printing plate, since a uniformly roughened surface is easily obtained. The electrolytic surface-roughening is ordinarily carried out in an aqueous hydrochloric acid or an aqueous nitric acid solution.

Various structures of surface profile on an aluminum support to improve printing suitability are known as described below.

Commonly known are, for example, a threefold structure having a large waveform, a medium waveform and a small waveform, in which the opening diameter of a medium waveform and a small waveform is specified in Japanese Patent Publication Open to Public Inspection No. 8-300844 (hereinafter referred to as Japanese Patent O.P.I. Publication); a structure in which the opening diameter of a small waveform is specified based on a twofold structure of large and small waveforms described in Japanese Patent O.P.I. Publication Nos. 11-99758 and 11-208138, in addition to coarse and fine double concave portions (pits) described in Japanese Patent O.P.I. Publication No. 11-167207; a technique by which microscopic protrusions are further added; a twofold structure in which the opening diameter described in Japanese Patent No. 2023475 is specified; a twofold structure in which a factor describing the smoothness of a surface is specified in Japanese Patent O.P.I. Publication No. 8-300843; and surface profile (refer to Patent Document 1) in which the ratio of Xa/Xb is 0.80-1.2, where Xa is a width expanding to the shallow region side and Xb is a width expanding to the deep region side at the position reaching peak depth in the amplitude frequency, according to a structure in which the ratio of pit diameters superposed during plural electrolytic surface-roughening treatment and the amplitude distribution curve of three dimensional surface roughness profile in which the number of at least 3 μm concave portions on the surface are not more than 60 per mm² (described in Japanese Patent O.P.I. Publication No. 10-35133).

However, a planographic printing plate material having an aluminum support, and an image formation layer provided thereon, is insufficient in desired dot reproduction, and is also specifically insufficient in printing durability in view of small dot printing durability and anti-stain property at non-image portions. Particularly when printing is carried out employing ink containing no VOC (volatile organic compound) especially from the aspect of environmental consciousness, the planographic printing plate provides poor dot reproduction, poor small dot printing durability, or poor printing durability in view of anti-stain property at non-image portions.

### SUMMARY

It is an object of the present invention to provide a planographic printing plate material exhibiting excellent dot reproduction and printing durability, and a support for the planographic printing plate material. In other words, a specific object of this invention is to provide a planographic printing plate material exhibiting excellent dot reproduction and printing durability, and a support for the planographic printing plate material, when printing is carried out employing ink containing no VOC (volatile organic compound).

### BRIEF DESCRIPTION OF THE DRAWINGS

Embodiments will now be described, by way of example only, with reference to the accompanying drawings which are meant to be exemplary, not limiting, and wherein like elements numbered alike in several Figures, in which: FIG. 1 is a diagram showing surface roughness curves and amplitude distribution curves,

FIG. 1(a) shows surface profile in the amplitude distribution curve in which the length expanding to the deep region side is larger than the length expanding to the shallow region side,

FIG. 1(b) shows surface profile in the amplitude distribution curve in which the length expanding to the deep region side is the same length expanding to the shallow region side,

FIG. 1(c) shows surface profile in the amplitude distribution curve in which the length expanding to the shallow region side is larger than the length expanding to the deep region side,

FIG. 2 shows enlarged views of the amplitude distribution curves shown in FIG. 1;

FIG. 2(a) is an enlarged view showing the amplitude distribution curve of FIG. 1(a),

FIG. 2(b) is an enlarged view showing the amplitude distribution curve of FIG. 1(b),

FIG. 2(c) is an enlarged view showing the amplitude distribution curve of FIG. 1(c), Xa and Xb are also shown in FIG. 2(a), FIG. 2(b) and FIG. 2(c), respectively; and

FIG. 3 is an image view showing an example of three dimension surface roughness of a support surface via measured data as three dimension surface roughness profile.

### BRIEF DESCRIPTION OF THE PREFERRED EMBODIMENTS

The above object of the present invention can be attained by the following structures.

(Structure 1) A support for a planographic printing plate material having a surface roughened via electrolytic surface-roughening treatment and anodization treatment conducted to one surface of an aluminum plate, wherein a) average surface roughness (Ra) of the roughened surface is 0.30-0.55 μm, and b) the roughened surface possesses a surface profile in which a ratio of Xa/Xb is 0.40-0.70, where Xa is a width expanding to a shallow region side and Xb is a width expanding to a deep region side at the position reaching peak depth in amplitude frequency.

(Structure 2) The support for a planographic printing plate material of Structure 1, wherein the aluminum plate further contains Mg of 0.1-0.4% by weight.

(Structure 3) A planographic printing plate material including the support of Structure 1 or 2, and an image formation layer provided on the support.

(Structure 4) The planographic printing plate material of Structure 3, wherein the image formation layer is a thermosensitive image formation layer.

(Structure 5) The planographic printing plate material of Structure 3 or 4, wherein the image formation layer is a photopolymerizable image formation layer.

(Structure 6) The planographic printing plate material of any one of Structures 3-5, wherein the image formation layer is a layer capable of being developed during printing.

While the preferred embodiments of the present invention have been described using specific terms, such description is for illustrative purposes only, and it is to be understood that changes and variations may be made without departing from the spirit or scope of the appended claims.

### DETAILED DESCRIPTION OF THE INVENTION

The present invention will be explained in detail below.

It is a feature in the present invention that based on a support for a planographic printing plate material having a surface roughened via electrolytic surface-roughening treatment and anodization treatment conducted to one surface of an aluminum plate, a) average surface roughness (Ra) of the roughened surface is 0.30-0.55 μm, and b) the roughened surface possesses a surface profile in which a ratio of Xa/Xb is 0.40-0.70, where Xa is the width expanding to the shallow region side and Xb is the width expanding to the deep region side at the position reaching peak depth in the amplitude frequency. Incidentally, in the case of the surface profile in which a ratio of Xa/Xb is 0.80-1.2, it is meant that almost the same amount of amplitude frequency regions is present on each of the shallow and deep region sides, and in the case of the ratio of Xa/Xb being 0.40-0.7, the amount of amplitude frequency regions on the deep region side is larger than on the shallow region side. Dot reproduction, printing durability and so forth are significantly improved by having a larger amount of amplitude frequency regions on the deep region side than on the shallow region side, when the ratio of Xa/Xb is 0.40-0.70.

A planographic printing plate material exhibiting excellent dot reproduction and printing durability in view of small dot printing durability and anti-stain property at non-image portions can be obtained by setting surface profile of the aluminum support to the above structure, particularly when printing is carried out employing ink containing no VOC (volatile organic compound).

(Support)

In the present invention, an aluminum plate is used for a planographic printing plate material support. Either a pure aluminum plate or an aluminum alloy plate may be used as the aluminum plate support.

As the aluminum alloy, used can be various ones including an alloy of aluminum and a metal such as silicon, copper, manganese, magnesium, chromium, zinc, lead, bismuth, nickel, titanium, sodium or iron. Further, a rolled aluminum plate may be used.

A recycled aluminum plate obtained by rolling aluminum recycled from scrapped or recycled materials, which has recently spread, is also acceptable.

It is preferable from the aspect of stain that printing durability is further improved with the aluminum plate containing Mg of 0.1-0.4% by weight. Incidentally, wear on the roughened surface is reduced since an aluminum plate is hardened by increasing Mg content at 0.1-0.4% by weight, and printing durable anti-stain property is improved.

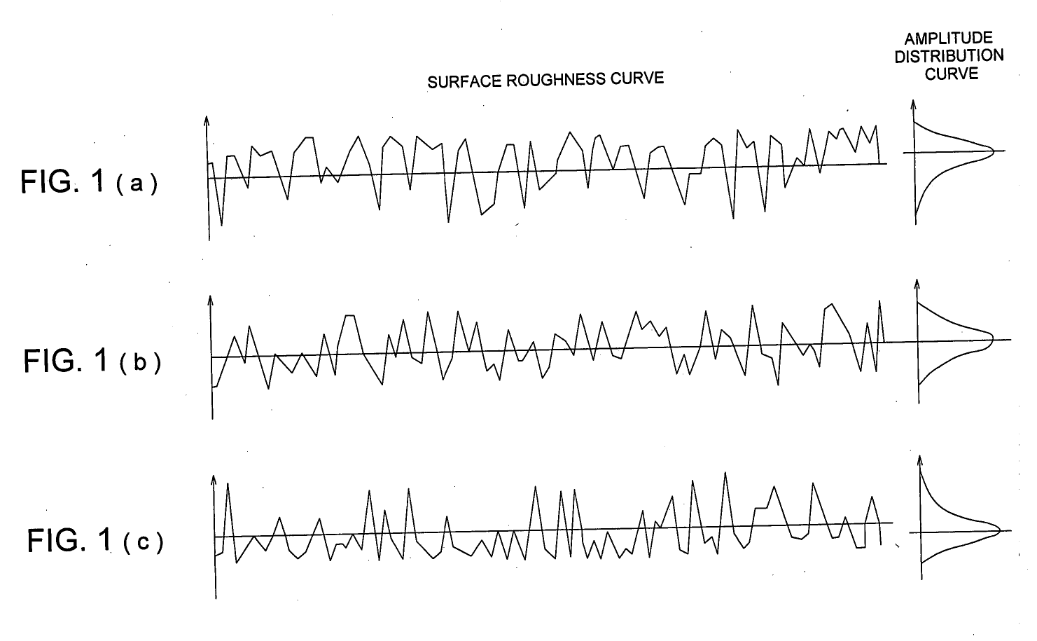

A ratio of Xa/Xb, where Xa is the width expanding to the shallow region side in the amplitude distribution curve and Xb is the width expanding to the deep region side in the amplitude distribution curve in the present invention, will be explained in FIGS. 1-3.

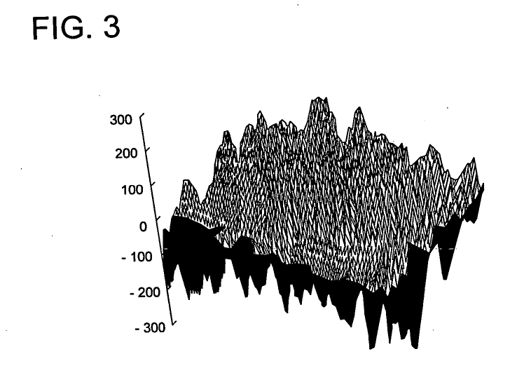

FIG. 3 is an image view showing an example of three dimension surface roughness of a support surface via measured data as three dimension surface roughness profile, and the amplitude distribution curve acquired from these data.

FIG. 1 is a diagram showing surface roughness curves and amplitude distribution curves. FIG. 1(a) shows surface profile in the amplitude distribution curve in which width Xb expanding to the deep region side is larger than width Xa expanding to the shallow region side (which, hereinafter, may be simply referred to as “the width expanding to the deep region side is larger”), FIG. 1(b) shows surface profile in the amplitude distribution curve in which the length expanding to the deep region side is the same length expanding to the shallow region side, and FIG. 1(c) shows surface profile in the amplitude distribution curve in which width Xa expanding to the shallow region side is larger than width Xb expanding to the deep region side (which, hereinafter, may be simply referred to as “the width expanding to the shallow region side is larger”).

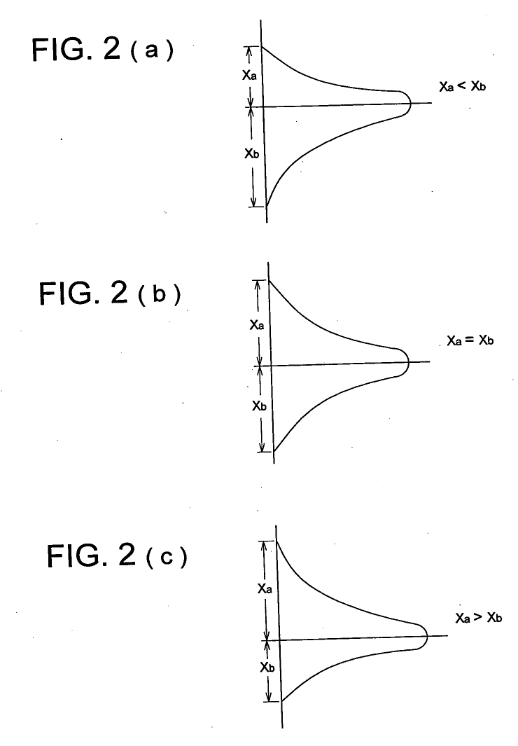

FIG. 2 shows enlarged views of the amplitude distribution curves shown in FIG. 1, and Xa and Xb are also shown in FIG. 2(a), FIG. 2(b) and FIG. 2(c), respectively.

A method for measuring ratio (Xa/Xb) of the above amplitude distribution curve of the planographic printing plate material support in the present invention is described below.

A plane surface of 400×400 μm was scanned at an interval of 0.01 μm employing a laser microscope to acquire three-dimension data, and amplitude distribution curves were obtained via arithmetic processing by loading the three-dimension data into a computer (refer to ISO 4287, for example).

Width Xa expanding to the shallow region side from the peak depth and width Xb expanding to the deep region side from the peak depth in the resulting amplitude distribution curve are measured to determine Xa/Xb.

The above measurement process is repeated 5 times, whereby the mean value is defined as the ratio of amplitude distribution curve (Xa/Xb).

It is essential that the roughened surface in the present invention has average surface roughness (Ra) of 0.4-0.6 μm.

Average surface roughness (Ra) in the present invention is specified in ISO 4287.

The surface roughness Ra (μm) is represented by the following equation, when a surface roughness curve is represented by formula Y=f(X) with measured length L in the center line direction which is extracted from the roughness curve with a cut-off value of 0.8 mm, the direction of the center line of the curve is set as the X-axis, and the direction of longitudinal magnification is set as the Y-axis;

$$Ra = \frac{1}{L} {\int }_{0}^{L} \vert f ( x ) \vert ⅆ x$$

Contact type surface roughness measuring instrument (SE 1700α produced by Kosaka Laboratory Ltd.), for example, can be utilized as the measuring apparatus to measure average surface roughness (Ra).

The above surface profile in the present invention is obtained by the following method.

It is preferable that the planographic printing plate material support in the present invention is subjected to degreasing treatment for removing rolling oil prior to electrolytically surface-roughening.

The degreasing treatments include degreasing treatment employing solvents such as trichlene and thinner, and an emulsion degreasing treatment employing an emulsion such as kerosene or triethanol.

It is also possible to use an aqueous alkali solution such as an aqueous solution of sodium hydroxide, or others for the degreasing treatment. When an aqueous alkali solution such as an aqueous solution of sodium hydroxide or others is used for the degreasing treatment, it is possible to remove soils and an oxidized film which can not be removed by the above-mentioned degreasing treatment alone. When the aqueous alkali solution such as an aqueous solution of sodium hydroxide or others is used for the degreasing treatment, the resulting plate is preferably subjected to desmut treatment in an aqueous solution of an acid such as phosphoric acid, nitric acid, sulfuric acid, chromic acid, or in an aqueous solution of a mixture thereof, since smut is produced on the surface of the support.

Prior to the electrolytic surface-roughening treatment in the present invention, electrolytic surface-roughening treatment may be carried out in an electrolytic solution containing nitric acid as a main component, or mechanical surface-roughening treatment may be carried out.

Though there is no restriction for the mechanical surface-roughening treatment, a brushing roughening method and a honing roughening method are preferable. The brushing roughening method is carried out by rubbing the surface of the plate with a rotating brush with a brush hair with a diameter of 0.2 to 0.8 mm, while supplying slurry in which volcanic ash particles with a particle size of 10 to 100 μm are dispersed in water to the surface of the plate. The honing roughening method is carried out by ejecting obliquely slurry with pressure applied from nozzles to the surface of the plate, the slurry containing volcanic ash particles with a particle size of 10 to 100 μm dispersed in water. Surface-roughening can be also carried out by laminating the plate surface with a sheet on the surface of which abrading particles with a particle size of 10-100 μm has been coated at intervals of 100 to 200 μm and at a density of 2.5×10³ to 10×10³/cm², and then applying pressure to the laminated sheet to transfer the roughened pattern of the sheet, whereby the plate surface is roughened.

After the plate has been roughened mechanically, it is preferably dipped in an acid or an aqueous alkali solution in order to remove abrasives and aluminum dust, etc. which have been embedded in the surface of the support. Examples of the acid include sulfuric acid, persulfuric acid, hydrofluoric acid, phosphoric acid, nitric acid and hydrochloric acid, and examples of the alkali include sodium hydroxide and potassium hydroxide. Among those mentioned above, an aqueous solution of alkali chemicals such as sodium hydroxide is preferably used. The dissolution amount of aluminum in the plate surface is preferably 0.5 to 5 g/m². After the plate has been dipped in the aqueous alkali solution, it is preferable for the plate to be dipped in an acid such as phosphoric acid, nitric acid, sulfuric acid and chromic acid, or in a mixed acid thereof, for neutralization.

In the electrolytic surface-roughening treatment carried out in the electrolytic solution containing nitric acid, voltage applied is generally 1-50 V, and preferably 10-30 V.

The current density used can be selected from the range of 10-200 A/dm², and is preferably 20-100 A/dm². The quantity of electricity can be selected from the range of 100-5000 C/dm², and is preferably 100-2000 C/dm². The temperature during the electrolytic surface-roughening treatment may be in the range of 10-50° C., and is preferably 15-45-° C. The nitric acid concentration in the electrolytic solution is preferably 0.1-5% by weight. It is possible to optionally add, to the electrolytic solution, nitrates, chlorides, amines, aldehydes, phosphoric acid, chromic acid, boric acid, acetic acid, oxalic acid or aluminum ions, if desired.

After the plate has been subjected to electrolytic surface-roughening treatment in the electrolytic solution containing nitric acid, it is preferably dipped in an acid or an aqueous alkali solution in order to remove abrasives and aluminum dust, etc. which have been embedded in the plate surface. Examples of the acid include sulfuric acid, persulfuric acid, hydrofluoric acid, phosphoric acid, nitric acid and hydrochloric acid, and examples of the alkali include sodium hydroxide and potassium hydroxide. Among those mentioned above, an aqueous alkali solution of for example, sodium hydroxide is preferably used.

The dissolution amount of aluminum in the plate surface is preferably 0.5 to 5 g/m². After the plate has been dipped in the aqueous alkali solution, it is preferable for the plate to be dipped in an acid such as phosphoric acid, nitric acid, sulfuric acid and chromic acid, or in a mixed acid thereof, for neutralization.

In the present invention, electrolytic surface-roughening treatment is preferably carried out in an electrolyte solution containing hydrochloric acid as a main component, employing an alternating current.

In the electrolytic surface-roughening treatment carried out in the electrolytic solution containing hydrochloric acid employing alternating current, the hydrochloric acid concentration in the electrolytic solution is 5-20 g/l, and preferably 6.5-16 g/l. The temperature of the electrolytic solution may be in the range of 15-35° C., and is preferably 18-38° C.

The aluminium iron concentration in the electrolytic solution is 0.5-15 g/l, and preferably 0.7-10 g/l. It is preferable that boric acid or acetic acid is contained in the electrolytic solution, the concentration is 1-20 g/l, and preferably 3-15 g/l. The ratio to the hydrochloric acid concentration is also 0.5-1.5. The current density is 15-120 A/dm², and preferably 20-90 A/dm². The quantity of electricity is 400-2000 C/dm2, and preferably 500-1200 C/dm². It is preferable that the frequency used is in the range of 40-150 Hz.

The planographic printing plate material in the present invention can be acquired by adjusting electrolytic conditions for the electrolytic surface-roughening treatment in the above-mentioned range. It is preferred, for example, that the aluminium ion concentration in the electrolytic solution is 3-7 g/l, the concentration of boric acid or acetic acid in the electrolytic solution is 7-13 g/l, and the ratio to the hydrochloric acid concentration is 0.7-1.2. It is also preferred that the current density is 15-90 A/dm², and the quantity of electricity is 500-1200 C/dm².

The electrolytic surface-roughening treatment employing an alternating current may be carried out stepwise. Examples which can be used include a method for varying the current density stepwise, a method for varying the alternating current waveform stepwise, a method for varying the frequency stepwise, and a method for varying the acidic electrolytic solution stepwise.

After the plate has been subjected to electrolytic surface-roughening treatment of the present invention in the electrolytic solution containing hydrochloric acid, it is preferably dipped in an acid or an aqueous alkali solution in order to remove aluminum dust, etc. produced in the plate surface. Examples of the acid include sulfuric acid, persulfuric acid, hydrofluoric acid, phosphoric acid, nitric acid and hydrochloric acid, and examples of the alkali include sodium hydroxide and potassium hydroxide. Among those mentioned above, a phosphoric acid or sodium hydroxide aqueous solution is preferably used. The dissolution amount of aluminum in the plate surface is preferably 0.1 to 2 g/m². After the plate has been dipped in the aqueous alkali solution, it is preferable for the plate to be dipped in an acid such as phosphoric acid, nitric acid, sulfuric acid and chromic acid, or in a mixed acid thereof, for neutralization.

After the electrolytic surface-roughening treatment, anodizing treatment is carried out.

There is no restriction in particular for the method of anodizing treatment used in the present invention, and known methods can be used. The anodizing treatment forms an anodization film on the plate surface. Generally, the anodizing treatment is carried out in an electrolytic solution containing sulfuric acid, phosphoric acid or their mixture applying a direct current. In the present invention, the anodizing treatment is carried out preferably in a sulfuric acid solution. The sulfuric acid concentration of the sulfuric acid solution is preferably 5-50% by weight, and more preferably 10-35% by weight. The temperature of the sulfuric acid solution is preferably 10-50° C. Voltage applied is preferably not less than 18 V, and more preferably not less than 20 V. Current density applied is preferably 1-30 A/dm². Quantity of electricity is preferably 100-500 C/dm².

The coated amount of the formed anodization film is suitably 1 to 50 mg/dm², and preferably 10 to 40 mg/dm². The coated amount of the formed anodization film can be obtained from the weight difference between the aluminum plates before and after dissolution of the anodization film. The anodization film of the aluminum plate is dissolved employing for example, an aqueous phosphoric acid chromic acid solution which is prepared by dissolving 35 ml of 85% by weight phosphoric acid and 20 g of chromium (IV) oxide in 1 liter of water. Micro pores are formed in the anodization film. The micro pore density in the anodization film is preferably from 400 to 700/μm², and more preferably from 400 to 600/μm².

The support, which has been subjected to anodizing treatment, is optionally subjected to sealing treatment. For the sealing treatment, it is possible to use known methods using hot water, boiling water, steam, a sodium silicate solution, an aqueous dicromate solution, a nitrite solution and an ammonium acetate solution.

After the above treatments, the resulting support is preferably subjected to hydrophilic treatment. The hydrophilic treatment method is not specifically limited. The support is suitably undercoated with a water soluble resin such as polyvinyl phosphonic acid, a polymer or copolymer having a sulfonic acid in the side chain, or polyacrylic acid; a water soluble metal salt such as zinc borate; a yellow dye, an amine salt; and so on. The sol-gel treatment support, which has a functional group capable of causing addition reaction by radicals as a covalent bond, is suitably used as described in Japanese Patent O.P.I. Publication No. 5-304358. It is preferred that the plate surface is subjected to hydrophilic treatment employing polyvinyl phosphoric acid. The hydrophilic treatment method is not specifically limited. There is for example, a coating method, a spraying method, or a dipping method. The dipping method is preferred in that the facility is cheap. The solution used in the dipping method is preferably an aqueous 0.05-3% polyvinyl phosphonic acid solution. The treating temperature is preferably 20-90° C., and the treating time is preferably 10-180 seconds. After the hydrophilic treatment, excessive polyvinyl phosphonic acid is removed from the support surface preferably through washing or squeegeeing. After that, it is preferred that the support is dried at preferably 90-250° C.

(Image Formation Layer)

The planographic printing plate material in the present invention possesses an image formation layer on the surface-roughened side of the planographic printing plate material support described above.

The image formation layer in the present invention is a layer capable of forming an image by imagewise exposure. As the image formation layer, a positive or negative working image formation layer used in a conventional light sensitive planographic printing plate material can be used.

As the image formation layer in the present invention, a thermosensitive image formation layer or polymerizable image formation layer is preferably used.

As the thermosensitive image formation layer, a layer capable of forming an image employing heat generated due to laser exposure is preferred.

As the layer capable of forming an image employing heat generated due to laser exposure, a positive working thermosensitive image formation layer containing a compound capable of being decomposed by an acid or a negative working image formation layer such as a thermosensitive image formation layer containing a polymerizable composition or a thermosensitive image formation layer containing thermoplastic particles are preferably used.

It is preferred that the thermosensitive image formation layer is removed during printing. It is preferred in other words that the thermosensitive image formation layer is a layer capable of developing during printing.

The layer capable of developing during printing is a layer capable of removing an image formation layer at non-image portions by a wetting solution or printing ink in the planographic printing after imagewise exposure.

As the positive working image formation layer containing a compound capable of being decomposed by an acid, there is, for example, an image formation layer comprising a photolytically acid generating compound capable of generating an acid on laser exposure, an acid decomposable compound, which is capable of being decomposed by an acid to increase solubility to a developer, and an infrared absorber, as disclosed in Japanese Patent O.P.I. Publication No. 9-171254.

As the photolytically acid generating compound there are various conventional compounds and mixtures. For example, a salt of diazonium, phosphonium, sulfonium or iodonium ion with BF₄⁻, PF₆⁻, SbF₆⁻ SiF₆²⁻ or ClO₄⁻, an organic halogen-containing compound, o-quinonediazide sulfonylchloride or a mixture of an organic metal and an organic halogen-containing compound is a compound capable of generating or releasing an acid on irradiation of an active light, and can be used as the photolytically acid generating compound in the present invention. The organic halogen-containing compound known as an photoinitiator capable of forming a free radical is a compound capable of generating a hydrogen halide and can be used as the photolytically acid generating compound. The examples of the organic halogen-containing compound capable of forming a hydrogen halide include those disclosed in U.S. Pat. Nos. 3,515,552, 3,536,489 and 3,779,778 and West German Patent No. 2,243,621, and compounds generating an acid by photodegradation disclosed in West German Patent No. 2,610,842. As the photolytically acid generating compound, o-naphthoquinone diazide-4-sulfonylhalogenides disclosed in Japanese Patent O.P.I. Publication No. 50-30209 can be also used.

As the photolytically acid generating compound, an organic halogen-containing compound is preferred in view of sensitivity to infrared rays and storage stability. The organic halogen-containing compound is preferably a halogenated alkyl-containing triazines or a halogenated alkyl-containing pxadiazoles, and especially preferably a halogenated alkyl-containing s-triazines.

The content of the photolytically acid generating compound in the image formation layer is preferably 0.1 to 20% by weight, and more preferably 0.2 to 10% by weight based on the total weight of the solid components of the image formation layer, although the content broadly varies depending on its chemical properties, or kinds or physical properties of image formation layer used.

As the acid decomposable compound, there are a compound having a C—O—C bond disclosed in Japanese Patent O.P.I. Publication Nos. 48-89003, 51-120714, 53-133429, 55-12995, 55-126236 and 56-17345, a compound having an Si—O—C bond disclosed in Japanese Patent O.P.I. Publication Nos. 60-37549 and 60-121446, another acid decomposable compound disclosed in Japanese Patent O.P.I. Publication Nos. 60-3625 and 60-10247, a compound having an Si—N bond disclosed in Japanese Patent O.P.I. Publication No. 61-16687, a carbonic acid ester disclosed in Japanese Patent O.P.I. Publication No. 61-94603, an orthocarbonic acid ester disclosed in Japanese Patent O.P.I. Publication No. 60-251744, an orthotitanic acid ester disclosed in Japanese Patent O.P.I. Publication No. 61-125473, an orthosilicic acid ester disclosed in Japanese Patent O.P.I. Publication No. 61-125474, an acetal or ketal disclosed in Japanese Patent O.P.I. Publication No. 61-155481 and a compound having a C—S bond disclosed in Japanese Patent O.P.I. Publication No. 61-87769. Of these compounds, the compound having a C—O—C bond, the compound having an Si—O—C bond, the orthocarbonic acid ester, the acetal or ketal or the silylether disclosed in Japanese Patent O.P.I. Publication Nos. 53-133429, 56-17345, 60-121446, 60-37549, 60-251744 and 61-155481 are preferable.

The content of the acid decomposable compound in the image formation layer is preferably 5 to 70% by weight, and more preferably 10 to 50% by weight based on the total weight of the solid components of the image formation layer. The acid decomposable compounds may be used alone or as an admixture of two or more kinds thereof.

The image formation layer in the present invention preferably contains a light-to-heat conversion material which is capable of changing exposure light to heat. Examples of the light-to-heat conversion material include the following light-to-heat conversion dye or light-to-heat conversion material substances.

[Light-to-Heat Conversion Dye]

The following light-to-heat conversion dyes can be used as described below.

Examples of the light-to-heat conversion dye include a general infrared absorbing dye such as a cyanine dye, a chloconium dye, a polymethine dye, an azulenium dye, a squalenium dye, a thiopyrylium dye, a naphthoquinone dye or an anthraquinone dye, and an organometallic complex such as a phthalocyanine compound, a naphthalocyanine compound, an azo compound, a thioamide compound, a dithiol compound or an indoaniline compound. Exemplarily, the light-to-heat conversion materials include those disclosed in Japanese Patent O.P.I. Publication Nos. 63-139191, 64-33547, 1-160683, 1-280750, 1-293342, 2-2074, 3-26593, 3-30991, 3-34891, 3-36093, 3-36094, 3-36095, 3-42281, 3-97589 and 3-103476. These compounds may be used singly or in combination.

Those described in Japanese Patent O.P.I. Publication Nos. 11-240270, 11-265062, 2000-309174, 2002-49147, 2001-162965, 2002-144750, and 2001-219667 can be preferably used.

[Other Light-to-Heat Conversion Materials]

In addition to the above light-to-heat conversion dyes, other light-to-heat conversion materials may be used in combination.

Examples of the light-to-heat conversion material include carbon, graphite, a metal and a metal oxide.

Furnace black and acetylene black is preferably used as the carbon. The graininess (d₅₀) thereof is preferably not more than 100 nm, and more preferably not more than 50 nm.

The graphite is one having a particle size of preferably not more than 0.5 μm, more preferably not more than 100 nm, and most preferably not more than 50 nm.

As the metal, any metal can be used as long as the metal is in a form of fine particles having preferably a particle size of not more than 0.5 μm, more preferably not more than 100 nm, and most preferably not more than 50 nm. The metal may have any shape such as spherical, flaky and needle-like. Colloidal metal particles such as those of silver or gold are particularly preferred.

As the metal oxide, materials having black color in the visible regions or materials which are electro-conductive or semi-conductive can be used.

Examples of the former include black iron oxide and black complex metal oxides containing at least two metals.

Examples of the latter include Sb-doped SnO₂ (ATO), Sn-added In₂O₃ (ITO), TiO₂, TiO prepared by reducing TiO₂ (titanium oxide nitride, generally titanium black).

Particles prepared by covering a core material such as BaSO₄, TiO₂, 9Al₂O₃.2B₂O and K₂O.nTiO₂ with these metal oxides is usable.

These oxides are particles having a particle size of not more than 0.5 μm, preferably not more than 100 nm, and more preferably not more than 50 nm.

As these light-to-heat conversion materials, black iron oxide or black complex metal oxides containing at least two metals are more preferred.

Examples of the black complex metal oxides include complex metal oxides comprising at least two selected from Al, Ti, Cr, Mn, Fe, Co, Ni, Cu, Zn, Sb, and Ba. These can be prepared according to the methods disclosed in Japanese Patent O.P.I. Publication Nos. 9-27393, 9-25126, 9-237570, 9-241529 and 10-231441.

The complex metal oxide used in the present invention is preferably a complex Cu—Cr—Mn type metal oxide or a Cu—Fe—Mn type metal oxide. The Cu—Cr—Mn type metal oxides are preferably subjected to the treatment disclosed in Japanese Patent O.P.I. Publication Nos. 8-27393 in order to reduce isolation of a 6-valent chromium ion. These complex metal oxides have a high color density and a high light heat conversion efficiency as compared with another metal oxide.

The primary average particle size of these complex metal oxides is preferably not more than 1.0 μm, and more preferably 0.01-0.5 μm. The primary average particle size of not more than 1.0 μm improves a light heat conversion efficiency relative to the addition amount of the particles, and the primary average particle size of 0.01-0.5 μm further improves a light heat conversion efficiency relative to the addition amount of the particles.

The light heat conversion efficiency relative to the addition amount of the particles depends of a dispersity of the particles, and the well-dispersed particles have a high light heat conversion efficiency.

Accordingly, these complex metal oxide particles are preferably dispersed according to a known dispersing method, separately to a dispersion liquid (paste), before being added to a coating solution for the particle containing layer. The metal oxides having a primary average particle size of less than 0.01 are not preferred since they are difficult to disperse. A dispersant is optionally used for dispersion. The addition amount of the dispersant is preferably 0.01-5% by weight, and more preferably 0.1-2% by weight, based on the weight of the complex metal oxide particles.

The image formation layer may contain a binder optionally.

As a positive working image formation layer, an image formation layer containing o-naphthoquinone is preferably used.

The light-to-heat conversion dye or light-to-heat conversion material described above may be contained in the image formation layer or in a layer adjacent thereto.

As an image formation layer containing a polymerizable component, there is an image formation layer containing a light-to-heat conversion material (a) having an absorption band in a wavelength region of 700-1300 nm, a polymerization initiator (b) and a polymerizable ethylenically unsaturated monomer (c).

(Light-to-Heat Conversion Material (a) Having an Absorption Band in a Wavelength Region of 700-1300 nm)

As the light-to-heat conversion material (a) having an absorption band in a wavelength region of 700-1300 nm, There are the infrared absorbing dyes described above. Preferred are dyes such as cyanine dyes, squalirium dyes, oxonol dyes, pyrylium dyes, thiopyrylium dyes, polymethine dyes, oil soluble phthalocyanine dyes, triarylamine dyes, thiazolium dyes, oxazolium dyes, polyaniline dyes, polypyrrole dyes and polythiophene dyes.

Besides the above, pigments such as carbon black, titanium black, iron oxide powder, and colloidal silver can be preferably used. Cyanine dyes as dyes, and carbon black as pigments are especially preferred, in view of extinction coefficient, light-to-heat conversion efficiency and cost.

The content of the light-to-heat conversion material having an absorption band in a wavelength region of 700-1300 nm in the image formation layer is different due to extinction coefficient of the colorant, but is preferably an amount giving a reflection density of 0.3-3.0, and preferably 0.5-2.0. For example, in order to obtain the above reflection density, the content of the cyanine dye in the image formation layer is 10 to 100 mg/m².

This light-to-heat conversion material also may be contained in the image formation layer or in a layer adjacent thereto.

(Polymerizable Initiator (b))

The photopolymerization initiator is a compound capable of initiating polymerization of an unsaturated monomer by laser. Examples thereof include carbonyl compounds, organic sulfur compounds, peroxides, redox compounds, azo or diazo compounds, halides and photo-reducing dyes disclosed in J. Kosar, “Light Sensitive Systems”, Paragraph 5, and those disclosed in British Patent No. 1,459,563.

Typical examples of the photopolymerization initiator include the following compounds:

A benzoin derivative such as benzoin methyl ether, benzoin i-propyl ether, or α,α-dimethoxy-α-phenylacetophenone; a benzophenone derivative such as benzophenone, 2,4-dichlorobenzophenone, o-benzoyl methyl benzoate, or 4,4′-bis (dimethylamino) benzophenone; a thioxanthone derivative such as 2-chlorothioxanthone, 2-1-propylthioxanthone; an anthraquinone derivative such as 2-chloroanthraquinone or 2-methylanthraquinone; an acridone derivative such as N-methylacridone or N-butylacridone; α,α-diethoxyacetophenone; benzil; fluorenone; xanthone; an uranyl compound; a triazine derivative disclosed in Japanese Patent Publication Nos. 59-1281 and 61-9621 and Japanese Patent O.P.I. Publication No. 60-60104; an organic peroxide compound disclosed in Japanese Patent O.P.I. Publication Nos. 59-1504 and 61-243807; a diazonium compound in Japanese Patent Publication Nos. 43-23684, 44-6413, 47-1604 and U.S. Pat. No. 3,567,453; an organic azide compound disclosed in U.S. Pat. Nos. 2,848,328, 2,852,379 and 2,940,853; orthoquinondiazide compounds disclosed in Japanese Patent Publication Nos. 36-22062, 37-13109, 38-18015 and 45-9610; various onium compounds disclosed in Japanese Patent Publication No. 55-39162, Japanese Patent O.P.I. Publication No. 59-14023 and “Macromolecules”, Volume 10, p. 1307 (1977); azo compounds disclosed in Japanese Patent Publication No. 59-142205; metal arene complexes disclosed in Japanese Patent O.P.I. Publication No. 1-54440, European Patent Nos. 109,851 and 126,712, and “Journal of Imaging Science”, Volume 30, p. 174 (1986); (oxo) sulfonium organoboron complexes disclosed in Japanese Patent O.P.I. Publication Nos. 4-56831 and 4-89535; titanocenes disclosed in Japanese Patent O.P.I. Publication Nos. 59-152396 and 61-151197; transition metal complexes containing a transition metal such as ruthenium disclosed in “Coordination Chemistry Review”, Volume 84, p. 85-277 (1988) and Japanese Patent O.P.I. Publication No. 2-182701; 2,4,5-triarylimidazol dimmer disclosed in Japanese Patent O.P.I. Publication No. 3-209477; carbon tetrabromide; organic halide compounds disclosed in Japanese Patent O.P.I. Publication No. 59-107344.

Furthermore, the following are cited as an example of a polymerization initiator. Compounds which can generate a radical disclosed in JP-A 2002-537419; polymerization initiators disclosed in Japanese Patent O.P.I. Publication Nos. 2001-175006, 2002-278057, and 2003-5363; onium salts which have two or more cation sections in the molecule disclosed in Japanese Patent O.P.I. Publication No. 2003-76010, N-nitrosamine compounds disclosed in Japanese Patent O.P.I. Publication No. 2001-133966; compounds which generate a radical with heat disclosed in Japanese Patent O.P.I. Publication No. 2001-343742, compounds which generate an acid or a radical with heat disclosed in Japanese Patent O.P.I. Publication No. 2002-6482; borates described in Japanese Patent O.P.I. Publication No. 2002-116539; compounds which generate an acid or a radical with heat disclosed in Japanese Patent O.P.I. Publication No. 2002-148790; photolytic or thermal polymerization initiators which have an unsaturated group of the polymerizable disclosed in Japanese Patent O.P.I. Publication No. 2002-207293; onium salts which have an anion of divalence or more as a counter ion disclosed in Japanese Patent O.P.I. Publication No. 2002-268217; sulfonyl sulfone compounds having a specified structure disclosed in Japanese Patent O.P.I. Publication No. 2002-328465; and compounds which generate a radical with heat disclosed in Japanese Patent O.P.I. Publication No. 2002-341519.

Especially preferable compounds are an onium salt and a poly halogenated compound.

The following are cited as the onium salt. Diazonium salts disclosed in S. I. Schlesinger, Photogr. Sci. Eng., 18, 387 (1974), T. S. Bal et al., Polymer, 21, 423 (1980); ammonium salts disclosed in U.S. Pat. Nos. 4,069,055, 4,069,056, 4,027,992; phosphonium salts disclosed in D.C. Necker et al., Macromolecules, 17, 2468 (1984), C. S. Wen et al., The, Proc. Conf. Rad. Curing ASIA, p478, Tokyo, Oct. (1988), U.S. Pat. Nos. 4,069,055 and 4,069,056; iodonium salts disclosed in J. V. Crivello et al., Macromorecules, 10 (6), 1307 (1977), Chem.& amp, Eng. News, Nov. 28, p31 (1988), E.P. No. 104,143, and U.S. Pat. Nos. 339,049, 410,201, Japanese Patent O.P.I. Publication Nos. 2-150848 and 2-296514; sulfonium salts disclosed in J. V. Crivello et al., Polymer J. 17, 73(1985), J. V. Crivello et al., J. Org. Chem., 43, 3055(1978), W. R. Watt et al., J. Polymer Sci., Polymer Chem. Ed., 22, 1789(1984), J. V. Crivello et al., Polymer Bull., 14, 279(1985), J. V. Crivello et al., Macromorecules, 14(5), 1141(1981), J. V. Crivello et al., J. Polymer Sci., Polymer Chem. Ed., 17, 2877(1979), EP Nos. 370,693, 3,902,114, 233, 567, 297, 443, 297,442, U.S. Pat. Nos. 4,933,377, 161, 811, 410, 201, 339,049, 4,760,013, 4,734,444, 2,833,827, DP Nos. 2,904,626, 3,604,580, and 3,604,581; selenonium salts disclosed in J. V. Crivello et al., Macromorecules, 10 (6), 1307 (1977), J. V. Crivello et al., J. Polymer Sci., and Polymer Chem. Ed., 17, 1047 (1979); and ammonium salts disclosed in C. S. Wen et al., Teh, Proc. Conf. Rad. Curing ASIA, p. 478 Tokyo, Oct. (1988).

Among the above onium salts, iodonium salts and sulfonium salts are especially preferred.

The preferred examples of the sulfonium salts are as follows:

Triphenylsulfonium tetrafluoroborate, methyldiphenyl sulfonium tetrafluoroborate, dimethylphenylsulfonium hexafluorophosphate, 4-butoxyphenyldiphenylsulfonium tetrafluoroborate, 4-chlorophenyldiphenylsulfonium hexafluorophosphate, tri(4-phenoxylphenyl)sulfonium hexafluorophosphate, di(4-ethoxyphenyl)methylsulfonium hexafluoroarsenate, 4-acetonyl phenyldiphenylsulfonium tetrafluoroborate, 4-thiomehoxyphenyl diphenylsulfonium hexafluorophosphate, di(methoxysulfonylphenyl)methylsulfonium hexafluoroantimonate, di(nitrophenyl)phenylsulfonium hexafluoroantimonate, di(carbomethoxyphenyl)methylsulfonium hexafluorophosphate, 4-acetamidophenyldiphenylsulfonium tetrafluoroborate, dimethylnaphthylsulfonium hexafluorophosphate, trifluoromethyldiphenylsulfonium tetrafluoroborate, p-(phenyl thiophenyl)diphenylsulfonium hexafluoroantimonate, 10-methyl phenoxathiinium hexafluorophosphate, 5-methylthianthrenium hexafluorophosphate, 10-phenyl-9,9-dimethylthioxanthenium hexafluorophosphate, triphenylsulfonium tetrakis (pentafluorophenyl) borate.

The preferred examples of the iodonium salts are as follows:

Diphenyliodonium iodide, diphenyliodonium hexafluoroantimonate, 4-chlorophenyliodonium tetrafluoroborate, di(4-chlorophenyl)iodonium hexafluoroantimonate, diphenyliodonium hexafluorophosphate, diphenyliodonium trifluoroacetate, 4-trifluoromethylphenyl iodonium tetrafluoroborate, diphenyliodonium hexafluoroaresenate, ditolyliodonium hexafluorophosphate, di(4-methoxyphenyl)iodonium hexafluoroantimonate, di(4-methoxy phenyl)iodonium chloride, phenyl(4-methylphenyl) iodonium tetrafluoroborate, di(2,4-dimethyl phenyl) iodonium hexafluoroantimonate, di(4-t-butylphenyl)iodonium hexafluoroantimonate, 2,2′-diphenyliodonium hexafluorophosphate, tolylcumyl diphenyliodonium tetrakis(pentafluorophenyl)borate.

A polyhalogenated compound is a compound containing a trihalogenomethyl group, dihalogenomethyl group or a dihalogenomethylene group in the molecule. Preferable examples are halogenated compounds represented by the following Formula (1) and an oxadiazole compound with the above-described halogenated groups. Among these, a polyhaloacetyl compound represented by formula (2) is especially preferred.
R¹—CY₂—(C═O)—R² Formula (1)
wherein R¹ represents a hydrogen atom, a halogen atom, an alkyl group, an aryl group, an acyl group, an alkylsulfonyl group, an arylsulfonyl group, an iminosulfonyl group or a cyano group; R² represents a monovalent substituent, provided that R¹ and R² may combine with each other to form a ring; and Y represents a halogen atom.
   CY₃—(C═O)—X—R³ Formula (2)
   wherein R³ represents a monovalent substituent; X represents —O— or —NR⁴—, in which R⁴ represents a hydrogen atom or an alkyl group, provided that R³ and R⁴ may combine with each other to form a ring; and Y represents a halogen atom. Among these, a compound having a polyhalogenated acetylamido group is preferably used.

A compound having an oxadiazole ring with a polyhalogenated methyl group is also preferably used.

The content of the polymerization initiator in the image formation layer is not specifically limited, but is preferably 0.1-20% by weight, and more preferably 0.8-15% by weight.

(Polymerizable Ethylenically Unsaturated Monomer (c))

The polymerizable ethylenically unsaturated monomer is a compound having a polymerizable unsaturated group. Examples thereof includeconventional radical polymerizable monomers, and polyfunctional monomers having plural ethylenically unsaturated bond and polyfunctional oligomers used in UV-curable resins.

The polymerizable ethylenically unsaturated monomer is not specifically limited, but preferred examples thereof include a monofunctional acrylate such as 2-ethylhexyl acrylate, 2-hydroxypropyl acrylate, glycerol acrylate, tetrahydrofurfuryl acrylate, phenoxyethyl acrylate, nonylphenoxyethyl acrylate, tetrahydrofurfuryloxyethyl acrylate, tetrahydrofurfuryloxyhexyl acrylate; a methacrylate, itaconate, crotonate or maleate alternative of the above acrylate; a bifunctional acrylate such as ethyleneglycol diacrylate, triethyleneglycol diacrylate, pentaerythritol diacrylate, hydroquinone diacrylate, resorcin diacrylate, hexanediol diacrylate, neopentyl glycol diacrylate, tripropylene glycol diacrylate, hydroxypivalic acid neopentyl glycol diacrylate, neopentyl glycol adipate diacrylate, diacrylate of hydroxypivalic acid neopentyl glycol-ε-caprolactone adduct, 2-(2-hydroxy-1,1-dimethylethyl)-5-hydroxymethyl-5-ethyl-1,3-dioxane diacrylate, tricyclodecanedimethylol acrylate, tricyclodecanedimethylol acrylate-ε-caprolactone adduct or 1,6-hexanediol diglycidylether diacrylate; a dimethacrylate, diitaconate, dicrotonate or dimaleate alternative of the above diacrylate; a polyfunctional acrylate such as trimethylolpropane triacrylate, ditrimethylolpropane tetraacrylate, trimethylolethane triacrylate, pentaerythritol triacrylate, pentaerythritol tetraacrylate, dipentaerythritol tetraacrylate, dipentaerythritol pentaacrylate, dipentaerythritol hexacrylate, dipentaerythritol hexacrylate-ε-caprolactone adduct, pyrrogallol triacrylate, propionic acid dipentaerythritol triacrylate, propionic acid dipentaerythritol tetraacrylate, hydroxypivalylaldehyde modified dimethylolpropane triacrylate or EO-modified products thereof; and a methacrylate, itaconate, crotonate or maleate alternative of the above polyfunctional acrylate.

A prepolymer can be used as described above, and the prepolymer can be used singly, as an admixture of the above described monomers and/or oligomers.

Examples of the prepolymer include polyester (meth)acrylate obtained by incorporating (meth)acrylic acid in a polyester of a polybasic acid such as adipic acid, trimellitic acid, maleic acid, phthalic acid, terephthalic acid, hymic acid, malonic acid, succinic acid, glutaric acid, itaconic acid, pyromellitic acid, fumalic acid, pimelic acid, sebatic acid, dodecanic acid or tetrahydrophthalic acid with a polyol such as ethylene glycol, ethylene glycol, diethylene glycol, propylene oxide, 1,4-butane diol, triethylene glycol, tetraethylene glycol, polyethylene glycol, grycerin, trimethylol propane, pentaerythritol, sorbitol, 1,6-hexanediol or 1,2,6-hexanetriol; an epoxyacrylate such as bisphenol A•epichlorhydrin•(meth)acrylic acid or phenol novolak•epichlorhydrin•(meth)acrylic acid obtained by incorporating (meth)acrylic acid in an epoxy resin; an urethaneacrylate such as ethylene glycol•adipic acid•tolylenediisocyanate•2-hydroxyethylacrylate, polyethylene glycol•tolylenediisocyanate•2-hydroxyethylacrylate, hydroxyethylphthalyl methacrylate•xylenediisocyanate, 1,2-polybutadieneglycol•tolylenediisocyanate•2-hydroxyethylacrylate or trimethylolpropane propylene glycol•tolylenediisocyanate•2-hydroxyethylacrylate, obtained by incorporating (meth)acrylic acid in an urethane resin; a silicone acrylate such as polysiloxane acrylate, or polysiloxane-diisocyanate-2-hydroxyethylacrylate; an alkyd modified acrylate obtained by incorporating a methacroyl group in an oil modified alkyd resin; and a spiran resin acrylate.

The image formation layer can contain a monomer such as a phosphazene monomer, triethylene glycol, an EO modified isocyanuric acid diacrylate, an EO modified isocyanuric acid triacrylate, dimethyloltricyclodecane diacrylate, trimethylolpropane acrylate benzoate, an alkylene glycol acrylate, or a urethane modified acrylate, or an addition polymerizable oligomer or prepolymer having a structural unit derived from the above monomer.

As a monomer used in combination in the image formation layer, there is a phosphate compound having at least one (meth)acryloyl group. The phosphate compound is a compound having a (meth)acryloyl group in which at least one hydroxyl group of phosphoric acid is esterified.

Besides the above compounds, compounds disclosed in Japanese Patent O.P.I. Publication Nos. 58-212994, 61-6649, 62-46688, 62-48589, 62-173295, 62-187092, 63-67189, and 1-244891, compounds described on pages 286 to 294 of “11290 Chemical Compounds” edited by Kagakukogyo Nipposha, and compounds described on pages 11 to 65 of “UV•EB Koka Handbook (Materials)” edited by Kobunshi Kankokai can be suitably used. Of these compounds, compounds having two or more acryl or methacryl groups in the molecule are preferable, and those having a molecular weight of not more than 10,000, and preferably not more than 5,000 are more preferable.

In the present invention, a polymerizable ethylenically unsaturated monomer having a tertiary amino group in the molecule can be used preferably. The monomer is not specifically limited to the chemical structure, but is preferably a hydroxyl group-containing tertiary amine modified with glycidyl methacrylate, methacrylic acid chloride or acrylic acid chloride. Typically, a polymerizable compound is preferably used which is disclosed in Japanese Patent O.P.I. Publication Nos. 1-203413 and 1-197213.

In the present invention, a reaction product of a polyhydric alcohol having a tertiary amine in the molecule, a diisocyanate and a compound having a hydroxyl group and an addition-polymerizable ethylenically double bond in the molecule is preferably used.

Examples of the polyhydric alcohol having tertiary amine in the molecule include triethanolamine, N-methyldiethanolamine, N-ethyldiethanolamine, N-ethyldiethanolamine, N-n-butyldiethanolamine, N-tert-butyldiethanolamine, N,N-di(hydroxyethyl)aniline, N,N,N′, N′-tetra-2-hydroxypropylethylenediamine, p-tolyldiethanolamine, N,N,N′,N′-tetra-2-hydroxyethylethylenediamine, N,N-bis(2-hydroxypropyl)aniline, allyldiethanolamine, 3-dimethylamino-1,2-propane diol, 3-diethylamino-1,2-propane diol, N,N-di(n-propylamino)-2,3-propane diol, N,N-di(iso-propylamino)-2,3-propane diol, and 3-(N-methyl-N-benzylamino)-1,2-propane diol, but the present invention is not specifically limited thereto.

Examples of the diisocyanate include butane-1,4-diisocyanate, hexane-1,6-diisocyanate, 2-methylpentane-1,5-diisocyanate, octane-1,8-diisocyanate, 1,3-diisocyanatomethylcyclohexanone, 2,2,4-trimethylhexane-1,6-diisocyanate, isophorone diisocyanate, 1,2-phenylene diisocyanate, 1,3-phenylene diisocyanate, 1,4-phenylene diisocyanate, tolylene-2,4-diisocyanate, tolylene-2,5-diisocyanate, tolylene-2,6-diisocyanate, 1,3-di(isocyanatomethyl)benzene, and 1,3-bis(1-isocyanato-1-methylethyl)benzene, but the present invention is not specifically limited thereto.

Examples of the compound having a hydroxyl group and an addition-polymerizable ethylenically double bond in the molecule are 2-hydroxyethyl methacrylate, 2-hydroxyethyl acrylate, 4-hydroxybutyl acrylate, 2-hydroxypropylene-1,3-dimethacrylate, and 2-hydroxypropylene-1-methacrylate-3-acrylate.

The reaction product can be synthesized according to the same method as a conventional method in which a urethaneacrylate compound is ordinarily synthesized employing a diol, a diisocyanate and an acrylate having a hydroxyl group.

Examples of the reaction product of a reaction product of a polyhydric alcohol having a tertiary amine in the molecule, a diisocyanate and a compound having a hydroxyl group and an addition-polymerizable ethylenically double bond in the molecule will be listed below.
M-1: A reaction product of triethanolamine (1 mole), hexane-1,6-diisocyanate (3 moles), and 2-hydroxyethyl methacrylate (3 moles)
M-2: A reaction product of triethanolamine (1 mole), isophorone diisocyanate (3 moles), and 2-hydroxyethyl methacrylate (3 moles)
M-3: A reaction product of N-n-butyldiethanolamine (1 mole), 1,3-bis(1-cyanato-1-methylethyl)benzene (2 moles), and 2-hydroxypropylene-1-methacrylate-3-acrylate (2 moles)
M-4: A reaction product of N-n-butyldiethanolamine (1 mole), 1,3-di(cyanatomethyl)benzene (2 moles), and 2-hydroxypropylene-1-methacrylate-3-acrylate (2 moles)
M-5: A reaction product of N-methydiethanolamine (1 mole), tolylene-2,4-diisocyanate (2 moles), and 2-hydroxypropylene-1,3-dimethacrylate (2 moles)
M-6: A reaction product of triethanolamine (1 mole), 1,3-bis(1-isocyanato-1-methylethyl)benzene (3 moles), and 2-hydroxyethyl methacrylate (3 moles)
M-7: A reaction product of ethylenediamine tetraethanol (1 mole), 1,3-bis(1-isocyanato-1-methylethyl)benzene (4 moles), and 2-hydroxyethyl methacrylate (4 moles)

In addition to the above, acrylates or methacrylates disclosed in Japanese Patent O.P.I. Publication Nos. 1-105238 and 2-127404 can be used.

The polymerizable ethylenically unsaturated monomer content of the image formation layer is preferably 5-80% by weight, and more preferably 15-60% by weight.

The image formation layer in the present invention containing the polymerizable component preferably contains an alkali soluble polymer.

The alkali soluble polymer is a polymer having a specific acid value, and as typical examples thereof, the following polymer having various structure can be preferably used.

Examples of the polymer include a polyacrylate resin, a polyvinylbutyral resin, a polyurethane resin, a polyamide resin, a polyester resin, an epoxy resin, a phenol resin, a polycarbonate resin, a polyvinyl butyral resin, a polyvinyl formal resin, a shellac resin, or another natural resin. These polymers can be used as an admixture of two or more thereof.

Among these, a polymer having a hydroxyl group or a carboxyl group is preferably used, and a polymer having a carboxyl group is more preferably used.

Among these is preferably a vinyl copolymer obtained by copolymerization of an acryl monomer, and more preferably a copolymer containing (a) a carboxyl group-containing monomer unit and (b) an alkyl methacrylate or alkyl acrylate unit as the copolymerization component.

Examples of the carboxyl group-containing monomer include an α,β-unsaturated carboxylic acid, for example, acrylic acid, methacrylic acid, maleic acid, maleic anhydride, itaconic acid, itaconic anhydride or a carboxylic acid such as a half ester of phthalic acid with 2-hydroxymethacrylic acid.

Examples of the alkyl methacrylate or alkyl acrylate include an unsubstituted alkyl ester such as methylmethacrylate, ethylmethacrylate, propylmethacrylate, butylmethacrylate, amylmethacrylate, hexylmethacrylate, heptylmethacrylate, octylmethacrylate, nonylmethacrylate, decylmethacrylate, undecylmethacrylate, dodecylmethacrylate, methylacrylate, ethylacrylate, propylacrylate, butylacrylate, amylacrylate, hexylacrylate, heptylacrylate, octylacrylate, nonylacrylate, decylacrylate, undecylacrylate, or dodecylacrylate; a cyclic alkyl ester such as cyclohexyl methacrylate or cyclohexyl acrylate; and a substituted alkyl ester such as benzyl methacrylate, 2-chloroethyl methacrylate, N,N-dimethylaminoethyl methacrylate, glycidyl methacrylate, benzyl acrylate, 2-chloroethyl acrylate, N,N-dimethylaminoethyl acrylate or glycidyl acrylate.

The polymer binder in the present invention can further contain, as another monomer unit, a monomer unit derived from the monomer described in the following items (1) through (14):
(1) A monomer having an aromatic hydroxy group, for example, o-, (p- or m-) hydroxystyrene, or o-, (p- or m-) hydroxyphenylacrylate;
(2) A monomer having an aliphatic hydroxy group, for example, 2-hydroxyethyl acrylate, 2-hydroxyethyl methacrylate, N-methylolacrylamide, N-methylolmethacrylamide, 4-hydroxybutyl acrylate, 4-hydroxybutyl methacrylate, 5-hydroxypentyl acrylate, 5-hydroxypentyl methacrylate, 6-hydroxyhexyl acrylate, 6-hydroxyhexyl methacrylate, N-(2-hydroxyethyl)acrylamide, N-(2-hydroxyethyl)methacrylamide, or hydroxyethyl vinyl ether;
(3) A monomer having an aminosulfonyl group, for example, m- or p-aminosulfonylphenyl methacrylate, m- or p-aminosulfonylphenyl acrylate, N-(p-aminosulfonylphenyl) methacrylamide, or N-(p-aminosulfonylphenyl)acrylamide;
(4) A monomer having a sulfonamido group, for example, N-(p-toluenesulfonyl)acrylamide, or N-(p-toluenesulfonyl)-methacrylamide;
(5) An acrylamide or methacrylamide, for example, acrylamide, methacrylamide, N-ethylacrylamide, N-hexylacrylamide, N-cyclohexylacrylamide, N-phenylacrylamide, N-nitrophenylacrylamide, N-ethyl-N-phenylacrylamide, N-4-hydroxyphenylacrylamide, or N-4-hydroxyphenylmethacrylamide;
(6) A monomer having a fluorinated alkyl group, for example, trifluoromethyl acrylate, trifluoromethyl methacrylate, tetrafluoropropyl methacrylate, hexafluoropropyl methacrylate, octafluoropentyl acrylate, octafluoropentyl methacrylate, heptadecafluorodecyl methacrylate, heptadecafluorodecyl methacrylate, or N-butyl-N-(2-acryloxyethyl)heptadecafluorooctylsulfonamide;
(7) A vinyl ether, for example, ethyl vinyl ether, 2-chloroethyl vinyl ether, propyl vinyl ether, butyl vinyl ether, octyl vinyl ether, or phenyl vinyl ether;
(8) A vinyl ester, for example, vinyl acetate, vinyl chroloacetate, vinyl butyrate, or vinyl benzoate;
(9) A styrene, for example, styrene, methylstyrene, or chloromethystyrene;
(10) A vinyl ketone, for example, methyl vinyl ketone, ethyl vinyl ketone, propyl vinyl ketone, or phenyl vinyl ketone;
(11) An olefin, for example, ethylene, propylene, isobutylene, butadiene, or isoprene;
(12) N-vinylpyrrolidone, N-vinylcarbazole, or N-vinylpyridine,
(13) A monomer having a cyano group, for example, acrylonitrile, methacrylonitrile, 2-pentenenitrile, 2-methyl-3-butene nitrile, 2-cyanoethyl acrylate, or o-, m- or p-cyanostyrene;
(14) A monomer having an amino group, for example, N,N-diethylaminoethyl methacrylate, N,N-dimethylaminoethyl acrylate, N,N-dimethylaminoethyl methacrylate, polybutadiene urethane acrylate, N,N-dimethylaminopropyl acrylamide, N,N-dimethylacrylamide, acryloylmorpholine, N-isopropylacrylamide, or N,N-diethylacrylamide.

Further another monomer may be copolymerized with the above monomer.

An unsaturated bond-containing copolymer, which is obtained by reacting the polymer having a carboxyl group with for example, a compound having a (meth)acryloyl group and an epoxy group, is also preferred.

Examples of the compound having a (meth)acryloyl group and an epoxy group in the molecule include glycidyl acrylate, glycidyl methacrylate and an epoxy group-containing unsaturated compound disclosed in Japanese Patent O.P.I. Publication No. 11-271969.

Of the above alkali soluble polymers, those giving an acid value of 30-200 are preferred. Of these, those further having a weight average molecular weight of 15,000-500,000 are especially preferred.

Of the above polymers, those having a polymerizable unsaturated group are preferred, and those having 5 to 50 mol % of the polymerizable unsaturated group as a repeating unit are especially preferred.

An alkali soluble polymer having a polymerizable unsaturated group can be synthesized according to a conventional method without any limitations.

For example, a method can be used which reacts a carboxyl group with a glycidyl group, or reacts a hydroxyl group with an isocyanate group.

Typically, the alkali soluble polymer is a reaction product obtained by reacting a copolymer having a carboxyl group-containing monomer unit with an aliphatic epoxy-containing unsaturated compound such as allyl glycidyl ether, glycidyl (meth)acrylate, α-ethylglycidyl (meth)acrylate, glycidyl crotonate, glycidyl isocrotonate, crotonyl glycidyl ether, itaconic acid monoalkylmonoglycidyl ester, fumaric acid monoalkylmonoglycidyl ester, or maleic acid monoalkylmonoglycidyl ester; or an alicyclic epoxy-containing unsaturated compound such as 3,4-epoxycyclohexylmethyl (meth)acrylate. In the present invention, when an amount of the carboxyl group reacted with the epoxy-containing unsaturated compound is represented in terms of mol %, The amount is preferably 5-50 mol %, and more preferably 10-30 mol % in view of sensitivity and printing durability.

Reaction of a copolymer having a carboxyl group-containing monomer unit with a compound having an epoxy group and an unsaturated group is carried out for example, at 80 to 120° C. for 1 to 50 hours. The reaction product can be synthesized according to a conventional polymerization method, for example, a method described in literatures such as W. R. Sorenson & T. W. Cambell “Kobunshi Gosei Jikkenho” published by TOKYO KAGAKU DOHJIN, or Japanese Patent O.P.I. Publication Nos. 10-315598 and 11-271963, or a method similar to the above.

The content of the alkali soluble polymer in the image formation layer is preferably 10-90% by weight, more preferably 15-70% by weight, and still more preferably 20-50% by weight.

Examples of the copolymer having a carboxyl group-containing monomer unit described above include a copolymer having at least one selected from units derived from the following monomers (1) through (17):
(1) A monomer having an aromatic hydroxy group;
(2) A monomer having an aliphatic hydroxy group;
(3) A monomer having an aminosulfonyl group;
(4) A monomer having a sulfonamido group;
(5) An α,β-unsaturated carboxylic acid;
(6) A substituted or unsubstituted alkyl acrylate;
(7) A substituted or unsubstituted alkyl acrylate;
(8) Acrylamide or methacrylamide;
(9) A monomer having a fluorinated alkyl group;
(10) A vinyl ether;
(11) A vinyl ester;
(12) A styrene;
(13) A vinyl ketone;
(14) An olefin;
(15) N-vinylpyrrolidone, N-vinylcarbazole, or N-vinylpyridine;
(16) A monomer having a cyano group; and
(17) A monomer having an amino group.

Typical examples thereof include a monofunctional acrylate such as 2-ethylhexyl acrylate, 2-hydroxypropyl acrylate, glycerol acrylate, tetrahydrofurfuryl acrylate, phenoxyethyl acrylate, nonylphenoxyethyl acrylate, tetrahydrofurfuryl-oxyethyl acrylate, tetrahydrofurfuryloxyhexanorideacrylate, an ester of 1,3-dioxane-ε-caprolactone adduct with acrylic acid, or 1,3-dioxolane acrylate; a methacrylate, itaconate, crotonate or maleate alternative of the above acrylate; a bifunctional acrylate such as ethyleneglycol diacrylate, triethyleneglycol diacrylate, pentaerythritol diacrylate, hydroquinone diacrylate, resorcin diacrylate, hexanediol diacrylate, neopentyl glycol diacrylate, tripropylene glycol diacrylate, hydroxypivalic acid neopentyl glycol diacrylate, neopentyl glycol adipate diacrylate, diacrylate of hydroxypivalic acid neopentyl glycol-ε-caprolactone adduct, 2-(2-hydroxy-1,1-dimethylethyl)-5-hydroxymethyl-5-ethyl-1,3-dioxane diacrylate, tricyclodecanedimethylol acrylate, tricyclodecanedimethylol acrylate-ε-caprolactone adduct or 1,6-hexanediol diglycidylether diacrylate; a dimethacrylate, diitaconate, dicrotonate or dimaleate alternative of the above diacrylate; a polyfunctional acrylate such as trimethylolpropane triacrylate, ditrimethylolpropane tetraacrylate, trimethylolethane triacrylate, pentaerythritol triacrylate, pentaerythritol tetraacrylate, dipentaerythritol tetraacrylate, dipentaerythritol pentaacrylate, dipentaerythritol hexacrylate, dipentaerythritol hexacrylate-ε-caprolactone adduct, pyrrogallol triacrylate, propionic acid dipentaerythritol triacrylate, propionic acid dipentaerythritol tetraacrylate or hydroxypivalylaldehyde modified dimethylolpropane triacrylate; a methacrylate, itaconate, crotonate or maleate alternative of the above polyfunctional acrylate.

(Polymer Binder)

The image formation layer in the present invention can contain a polymer binder.

Examples of the polymer binder include a polyacrylate resin, a polyvinylbutyral resin, a polyurethane resin, a polyamide resin, a polyester resin, an epoxy resin, a phenol resin, a polycarbonate resin, a polyvinyl butyral resin, a polyvinyl formal resin, a shellac resin, or another natural resin. These can also be used as an admixture of two or more thereof.

(Polymerization Inhibitor)

The image formation layer in the present invention can optionally a polymerization inhibitor.

As the polymerization inhibitor, there is for example, a hindered amine with a pKb of 7-14 having a piperidine skeleton.

The polymerization inhibitor content is preferably 0.001-10% by weight, more preferably 0.01-10% by weight, and still more preferably 0.1-5% by weight based on the total solid content of polymerizable unsaturated group-containing compound in the image formation layer.

The image formation layer in the present invention may contain a second polymerization inhibiter other than the above-described polymerization inhibiter. Examples of the second polymerization inhibiter include hydroquinone, p-methoxyphenol, di-t-butyl-p-cresol, pyrrogallol, t-butylcatechol, benzoquinone, 4,4′-thiobis (3-methyl-6-t-butylphenol), 2,2′-methylenebis (4-methyl-6-t-butylphenol), N-nitrosophenylhydroxylamine cerous salt, and 2-t-butyl-6-(3-t-butyl-6-hydroxy-5-mrthylbenzyl)-4-methylphenyl acrylate.

The image formation layer can contain a colorant. As the colorant can be used known materials including commercially available materials. Examples of the colorant include those described in revised edition “Ganryo Binran”, edited y Nippon Ganryo Gijutu Kyoukai (publishe by Seibunndou Sinkosha), or “Color Index Binran”. Pigment is preferred.

Kinds of the pigment include black pigment, yellow pigment, red pigment, brown pigment, violet pigment, blue pigment, green pigment, fluorescent pigment, and metal powder pigment. Examples of the pigment include inorganic pigment (such as titanium dioxide, carbon black, graphite, zinc oxide, Prussian blue, cadmium sulfide, iron oxide, or chromate of lead, zinc, barium or calcium); and organic pigment (such as azo pigment, thioindigo pigment, anthraquinone pigment, anthanthrone pigment, triphenedioxazine pigment, vat dye pigment, phthalocyanine pigment or its derivative, or quinacridone pigment).

Among these, pigment is preferably used which does not substantially have absorption in the absorption wavelength regions of a spectral sensitizing dye used according to a laser for exposure. The absorption of the pigment used is not more than 0.05, obtained from the reflection spectrum of the pigment measured employing an integrating sphere and employing light with the wavelength of the laser used. The pigment content is preferably 0.1 to 10% by weight, and more preferably 0.2 to 5% by weight, based on the total solid content of image formation layer.

In the present invention, a protective layer is preferably provided on the image formation layer. It is preferred that the protective layer (oxygen shielding layer) is highly soluble in a developer as described later (generally an alkaline solution). The protective layer preferably contains polyvinyl alcohol and polyvinyl pyrrolidone. Polyvinyl alcohol has the effect of preventing oxygen from transmitting and polyvinyl pyrrolidone has the effect of increasing adhesion between the oxygen shielding layer and the image formation layer adjacent thereto.

Besides the above two polymers, the oxygen shielding layer may contain a water soluble polymer such as polysaccharide, polyethylene glycol, gelatin, glue, casein, hydroxyethyl cellulose, carboxymethyl cellulose, methyl cellulose, hydroxyethyl starch, gum arabic, sucrose octacetate, ammonium alginate, sodium alginate, polyvinyl amine, polyethylene oxide, polystyrene sulfonic acid, polyacrylic acid, or a water soluble polyamide.

The polymerizable image formation layer in the present invention is an image formation layer containing a polymerization initiator and a polymerizable unsaturated group-containing compound, and as the polymerization initiator and polymerizable unsaturated group-containing compound, those described above can be used.

As a photopolymerization initiator in the polymerizable image formation layer, a titanocene compound, a triarylmonoalkylborate compound, an iron-arene complex or a trihaloalkyl compound is preferably used.

As the titanocene compounds, there are compounds disclosed in Japanese Patent O.P.I. Publication Nos. 63-41483 and 2-291. Preferred examples thereof include bis(cyclopentadienyl)-Ti-dichloride, bis(cyclopentadienyl)-Ti-bisphenyl, bis(cyclopentadienyl)-Ti-bis-2.,3,4,5,6-pentafluorophenyl, bis(cyclopentadienyl)-Ti-bis-2,3,5,6-tetrafluorophenyl, bis(cyclopentadienyl)-Ti-bis-2,4,6-trifluorophenyl, bis(cyclopentadienyl)-Ti-bis-2,6-difluorophenyl, bis(cyclopentadienyl)-Ti-bis-2,4-difluorophenyl, bis(methylcyclopentadienyl)-Ti-bis-2,3,4,5,6-pentafluorophenyl, bis(methylcyclopentadienyl)-Ti-bis-2,3,5,6-tetrafluorophenyl, bis(methylcyclopentadienyl)-Ti-bis-2,4-difluorophenyl (IRUGACURE 727L, produced by Ciba Specialty Co., Ltd.), bis(cyclopentadienyl)-bis(2,6-difluoro-3-(pyry-1-yl)phenyl) titanium (IRUGACURE 784, produced by Ciba Specialty Co., Ltd.), bis(cyclopentadienyl)-bis(2,4,6-trifluoro-3-(pyry-1-yl)phenyl) titanium, and bis (cyclopentadienyl)-bis (2,4,6-trifluoro-3-(2,5-dimethylpyry-1-yl)phenyl) titanium.

As the monoalkyltriaryl borate compounds, there are those described in Japanese Patent O.P.I. Publication Nos. 62-150242 and 62-143044. Preferred examples of the monoalkyl-triatyl borate compounds include tetra-n-butyl ammonium n-butyl-trinaphthalene-1-yl-borate, tetra-n-butyl ammonium n-butyl-triphenyl-borate, tetra-n-butyl ammonium n-butyl-tri-(4-tert-butylphenyl)-borate, tetra-n-butyl ammonium n-hexyl-tri-(3-chloro-4-methylphenyl)-borate, and tetra-n-butyl ammonium n-hexyl-tri-(3-fluorophenyl)-borate.

As the iron arene complexes, there are those described in Japanese Patent O.P.I. Publication No. 59-219307. Preferred examples of the iron arene complex include η-benzene-(η-cyclopentadienyl)iron•hexafluorophosphate, η-cumene)-(η-cyclopentadienyl)iron•hexafluorophosphate, η-fluorene-(η-cyclopentadienyl)iron•hexafluorophosphate, η-naphthalene-(η-cyclopentadienyl)iron•hexafluorophosphate, η-xylene-(η-cyclopentadienyl)iron•hexafluorophosphate, and η-benzene-(η-cyclopentadienyl)iron•tetrafluoroborate.

As the trihaloalkyl compound, the trihaloalkyl compound described above can be used.

Any other polymerization initiator can also be used in combination.

As the polymerization initiator, there are, for example, cumarin derivatives B-1 through B-22 disclosed in Japanese Patent O.P.I. Publication No. 8-129258, cumarin derivatives D-1 through D-32 disclosed in Japanese Patent O.P.I. Publication No. 2003-121901, cumarin derivatives 1 through 21 disclosed in Japanese Patent O.P.I. Publication No. 2002-363206, cumarin derivatives 1 through 40 disclosed in Japanese Patent O.P.I. Publication No. 2002-363207, cumarin derivatives 1 through 34 disclosed in Japanese Patent O.P.I. Publication No. 2002-363208, and cumarin derivatives 1 through 56 disclosed in Japanese Patent O.P.I. Publication No. 2002-363209.

(Spectral Sensitizing Dye)

A sensitizing dye having an absorption maximum in the wavelength of light-emitted from the light source or in the vicinity of the wavelength is preferably employed as a sensitizing dye used for a polymerizable image formation layer.

Examples of the sensitizing dyes, which can induce sensitivity to the wavelengths of visible to near infrared regions (350-1300 nm), include cyanines, phthalocyanines, merocyanines, porphyrins, spiro compounds, ferrocenes, fluorenes, fulgides, imidazoles, perylenes, phenazines, phenothiazines, polyenes, azo compounds, diphenylmethanes, triphenylmethanes, polymethine acridines, cumarines, ketocumarines, quinacridones, indigos, styryl dyes, pyrylium dyes, pyrromethene dyes, pyrazolotriazole compounds, benzothiazole compounds, barbituric-acid derivatives, thiobarbituric acid derivatives, ketoalcohol borate complexes, and compounds disclosed in European Patent No. 568,993, U.S. Pat. Nos. 4,508,811 and 5,227,227, and Japanese Patent O.P.I. Publication Nos. 2001-125255 and 11-271969.

Examples in which the above polymerization initiators are used in combination with the sensitizing dye are disclosed in Japanese Patent O.P.I. Publication Nos. 2001-125255 and 11-271969.

It is preferred that the image formation layer contains a sensitizing dye in an amount providing a reflection density of 0.1-1.2 at the printing plate material surface. The sensitizing dye content of the image formation layer greatly differs due to molar extinction coefficient of the sensitizing dye or crystallinity in the image formation layer of the sensitizing dye, and is ordinarily 0.5-10% by weight.

The polymerizable image formation layer can contain the polymer binder described above as a polymer binder.

(Additives)

The polymerizable image formation layer in the invention may contain a hindered phenol compound, a hindered amine compound or other polymerization inhibitors in addition to the compounds described above, in order to prevent undesired polymerization of the ethylenically unsaturated monomer during the manufacture or storage of the planographic printing plate material.

Examples of the hindered amine compound include bis(1,2,2,6,6-pentamethyl-4-piperidyl)sebacate, bis(2,2,6,6-tetramethyl-4-piperidyl)sebacate, 1-[2-{3-(3,5-di-t-butyl-hydroxyphenyl)propionyloxy}ethyl]-4-[2-{3-(3,5-di-t-butyl-hydroxyphenyl)propionyloxy}ethyl]-2,2,6,6-tetramethylpiperidine-4-benzoyloxy-2,2,6,6-tetramethylpiperidine, and 8-acetyl-3-dodecyl-7,7,9,9-tetramethyl-1,3,8-triazaspiro-[4.5]decane-2,4-dione.

Examples of another polymerization inhibitor include hydroquinone, p-methoxyphenol, di-t-butyl-p-cresol, pyrrogallol, t-butylcatechol, benzoquinone, 4,4′-thiobis (3-methyl-6-t-butylphenol), 2,2′-methylenebis (4-methyl-6-t-butylphenol), N-nitrosophenylhydroxylamine cerous salt, and hindered amines such as 2,2,6,6-tetramethylpiperidine derivatives and others.

The polymerization inhibitor content is preferably 0.01 to 5% by weight based on the total solid content of the image formation layer. Further, in order to prevent polymerization induced by oxygen, a higher fatty acid such as behenic acid or a higher fatty acid derivative such as behenic amide may be added to the light sensitive layer, or may be localized on the surface of the light sensitive layer in the course of drying after coating. The higher fatty acid or higher fatty acid derivative content is preferably 0.5 to 10% by weight based on the total solid content of the image formation layer.

The polymerizable image formation layer can contain further the colorant described above.

(Coating)

Solvents used in the preparation of the coating solution for the image formation layer in the present invention include alcohol such as sec-butanol, isobutanol, n-hexanol, or benzyl alcohol; a polyhydric alcohol such as diethylene glycol, triethylene glycol, tetraethylene glycol, or 1,5-pentanediol; an ether such as propylene glycol monobutyl ether, dipropylene glycol monomethyl ether, or tripropylene glycol monomethyl ether; a ketone or aldehyde such as diacetone alcohol, cyclohexanone, or methyl cyclohexanone; and an ester such as ethyl lactate, butyl lactate, diethyl oxalate, or methyl benzoate.

The coating solution for the image formation layer is coated on a support according to a conventional method, and dried to obtain a polymerizable planographic printing plate material. Examples of the coating method include an air doctor coating method, a blade coating method, a wire bar coating method, a knife coating method, a dip coating method, a reverse roll coating method, a gravure coating method, a cast coating method, a curtain coating method, and an extrusion coating method.

The drying temperature of a coated image formation layer is preferably 60-160° C., more preferably 80-140° C., and still more preferably 90-120° C.

(Protective Layer)

A protective layer is preferably provided on the image formation layer in the invention. It is preferred that the protective layer (oxygen shielding layer) is highly soluble in a developer (generally an alkaline solution).

Materials constituting the protective layer are preferably polyvinyl alcohol, polysaccharide, polyvinyl pyrrolidone, polyethylene glycol, gelatin, glue, casein, hydroxyethyl cellulose, carboxymethyl cellulose, methyl cellulose, hydroxyethyl starch, gum arabic, sucrose octacetate, ammonium alginate, sodium alginate, polyvinyl amine, polyethylene oxide, polystyrene sulfonic acid, polyacrylic acid, or a water soluble polyamide. These materials may be used alone or in combination. Especially preferred material is polyvinyl alcohol.

A coating solution for the protective layer is obtained by dissolving the materials described above in a solvent. The coating solution is coated on the light sensitive layer and dried to form a protective layer. The dry thickness of the protective layer is preferably 0.1-5.0 μm, and more preferably 0.5-3.0 μm. The protective layer may contain a surfactant or a matting agent.

The same coating method as described above in the image formation layer can be applied as the protective layer coating method. The drying temperature of the protective layer is preferably lower than that of the image formation layer. The former is preferably not less than 10° C. lower than that of the latter, more preferably not less than 20° C. lower than that of the latter, and at most 50° C. lower than that of the latter.

Further, the drying temperature of the protective layer is preferably lower than a glass transition temperature (Tg) of the binder contained in the image formation layer. The drying temperature of the protective layer is preferably not less than 20° C. lower than Tg of the binder contained in the image formation layer, and more preferably not less than 40° C. lower than Tg pf the binder contained in the image formation layer. The drying temperature of the protective layer is preferably at most 60° C. lower than Tg of the binder contained in the image formation layer.

(Plate-Making and Printing)

The planographic printing plate material of the present invention is imagewise exposed to form an image, and then optionally developed to obtain a printing plate which is applied for printing.

The light sources for the imagewise exposure include, for example, a laser, a light emitting diode, a xenon flush lamp, a halogen lamp, a carbon arc light, a metal halide lamp, a tungsten lamp, a high pressure mercury lamp, and a non-electrode light source.

When the planographic printing plate precursor is imagewise exposed at one time, a mask material having a negative image pattern made of a light shielding material is provided on the image formation layer to be in close contact with the image formation layer, and exposure is carried out through the mask.

When an array light such as a light emitting diode array is used or exposure using a halogen lamp, a metal halide lamp or a tungsten lamp is controlled using an optical shutter material such as liquid crystal or PLZT, a digital exposure according to an image signal is possible and preferable. In this case, direct writing is possible without using any mask material.

When a laser is used for exposure, which can be condensed in the beam form, scanning exposure according to an image can be carried out, and direct writing is possible without using any mask material. When the laser is employed for imagewise exposure, a highly dissolved image can be obtained, since it is easy to condense its exposure spot in minute size.

A laser is used for imagewise exposure in the present invention, and it is preferred that an image is formed.

In other words, it is a feature that the planographic printing plate material described in the aforesaid Structures 3-6 is imagewise exposed to a laser to form an image, and then printing is conducted.

A laser scanning method by means of a laser beam includes a method of scanning on an outer surface of a cylinder, a method of scanning on an inner surface of a cylinder and a method of scanning on a plane. In the method of scanning on an outer surface of a cylinder, laser beam exposure is conducted while a drum around which a recording material is wound is rotated, in which main scanning is represented by the rotation of the drum, while sub-scanning is represented by the movement of the laser beam. In the method of scanning on an inner surface of a cylinder, a recording material is fixed on the inner surface of a drum, a laser beam is emitted from the inside, and main scanning is carried out in the circumferential direction by rotating a part of or an entire part of an optical system, while sub-scanning is carried out in the axial direction by moving straight a part of or an entire part of the optical system in parallel with a shaft of the drum. In the method of scanning on a plane, main scanning by means of a laser beam is carried out through a combination of a polygon mirror, a galvano mirror and an Fθ lens, and sub-scanning is carried out by moving a recording medium. The method of scanning on an outer surface of a cylinder, and the method of scanning on an inner surface of a cylinder are preferred in optical system accuracy and high density recording.

When the planographic printing plate material is developed, an automatic developing machine is ordinarily used.

Printing is carried out employing a conventional printing press.

In recent years, printing ink containing no petroleum volatile organic compound (VOC) has been developed and used in view of environmental concern. The present invention provides excellent effects specifically in employing such an environmentally conscious printing ink.

In other words, it is preferred that the planographic printing plate material described in the aforesaid Structures 3-6 is imagewise exposed to a laser to form an image, and then printing is conducted employing printing ink containing no petroleum volatile organic compound (VOC). Examples of such the printing ink include soybean oil ink “Naturalith 100” produced by Dainippon Ink Kagaku Kogyo Co., Ltd, VOC zero ink “TK HIGH ECO NV” produced by Toyo Ink Manufacturing Co., Ltd., and process ink “SOYCERVO” produced by Tokyo Ink Co., Ltd.

### EXAMPLE

Next, the present invention will be explained employing examples, but the present invention is not limited thereto. In the examples, “parts” represents “parts by weight”, unless otherwise specified.

### Example 1

(Preparation of Supports 1-11)

A 0.3 mm thick aluminum plate (described below) was immersed in a 3% sodium hydroxide solution at 50° C., degreased for 30 seconds, and then washed with water.

This degreased aluminum plate was immersed at 25° C. for 10 seconds in a 5% nitric acid solution to neutralize, and then washed with water.

Next, electrolytic surface-roughening treatment was carried out in an acidity solution of the condition described in Table 1, using a sinewave alternating current.

After the electrolytic surface-roughening treatment, the above aluminum plate was immersed at 55° C. for 10 seconds in a 75 g/l phosphoric acid solution, desmut treatment was conducted, and then washed with water.

Next, the surface roughened support was anodized in a 25° C. 200 g/l sulfuric acid and 1.5 g/l of aluminum 10% sodium hydroxide solution at a current density of 5 A/dm², employing a direct-current power source, and washed with water to form an anodization film with a thickness of 20 mg/dm².

Subsequently, dipping treatment of the aluminum plate was carried out in an aqueous 0.2% solution of polyvinyl phosphonic acid at 60° C. for 30 seconds, washed with water, and hot-air dried at 150° C. Thus, supports 1-11 were prepared.

Average surface roughness (Ra) of this support and the ratio of amplitude distribution curve (Xa/Xb) are shown in Table 1.

Aluminum plate 1 (material 1052, containing not less than 99.3% of Al, 0.003% of Na, 0.20% of Mg, 0.08% of Si, 0.006% of Ti, 0.004% of Mn, 0.32% of Fe, 0.004% of Ni, 0.002% of Cu, 0.015% of Zn, and 0.007% of Ga)

Aluminum plate 2 (material 1050, containing not less than 99.5% of Al, 0.006% of Na, 0.01% of Mg, 0.04% of Si, 0.03% of Ti, 0.004% of Mn, 0.32% of Fe, 0.004% of Ni, 0.006% of Cu, 0.005% of Zn, and 0.01% of Ga)

(Measurement of Average Surface Roughness Ra)

The surface roughness was two-dimensionally measured by a contact type surface roughness instrument (SE 1700α, produced by Kosaka Laboratory Ltd.), and average surface roughness (Ra) was measured 5 times according to ISO 4287 to determine a mean value.

The surface roughness was measured under the following conditions (cutting off of 0.8 mm, a scanning length of 4 mm, a scanning speed of 0.1 mm/second, and a stylus having a tip diameter of 2 μm).

(Ratio of Amplitude Distribution Curve)

Xa/Xb was measured by a laser microscope (VK5800, produced by Keyence Corp.) according to ISO 4287.

A plane surface of 400×400 μm was scanned at an interval of 0.01 μm to acquire three-dimension data, and amplitude distribution curves were obtained via arithmetic processing by loading the three-dimension data into a computer. A ratio of Xa/Xb was determined by measuring Xa; a width expanding to the shallow region side from the peak depth of the resulting amplitude distribution curve as well as Xb; a width expanding to the deep region side from the peak.depth of the resulting amplitude distribution curve. This measurement was conducted 5 times, and the mean value obtained was used.

TABLE 1

| First stage electrolysis condition | | | |
|---|---|---|---|
| Electrolytic | Current | | |
| solution | density | *6 | *7 |

| | | *2 | *3 | Al ion | *4 | *5 | D1 | t1 | Q1 |
|---|---|---|---|---|---|---|---|---|---|
| Support | *1 | (g/l) | (g/l) | (g/l) | (g/l) | (° C.) | (A/dm²) | (sec) | (C/dm²) |
| 1 | 1 | 11 | | 5 | 10 | 25 | 50 | 15 | 750 |
| 2 | 2 | 11 | | 5 | 10 | 25 | 50 | 15 | 750 |
| 3 | 1 | 11 | | 5 | 10 | 25 | 50 | 10 | 500 |
| 4 | 1 | 11 | | 5 | 10 | 25 | 50 | 16 | 800 |
| 5 | 1 | 11 | | 5 | 10 | 25 | 50 | 10 | 500 |
| 6 | 1 | 11 | | 5 | 10 | 25 | 50 | 18 | 900 |
| 7 | 1 | 11 | | 5 | 30 | 25 | 50 | 20 | 1000 |
| 8 | 1 | | 11 | 5 | 30 | 25 | 40 | 15 | 600 |
| 9 | 1 | | 11 | 5 | 30 | 25 | 40 | 15 | 600 |
| 10 | 1 | 11 | | 5 | | 25 | 50 | 15 | 750 |
| 11 | 1 | 11 | | 5 | 10 | 25 | 50 | 20 | 1000 |

| | | Second stage electrolysis condition | | | | | | | | | | |
|---|---|---|---|---|---|---|---|---|---|---|---|---|
| | | Electrolytic | | | | | | | | | | |
| | | solution | | | | Current | | | | | | |
| | | | Al | | | density | *6 | *7 | | | | |
| | | *2 | ion | *4 | *5 | D2 | t2 | Q2 | *8 | *9 | *10 | |
| Support | *1 | (g/l) | (g/l) | (g/l) | (° C.) | (A/dm²) | (sec) | (C/dm²) | Q1 + Q2 | Ra | Xa/Xb | Remarks |
| 1 | 1 | 11 | 5 | 10 | 25 | 20 | 15 | 300 | 1050 | 0.50 | 0.50 | Inv. |
| 2 | 2 | 11 | 5 | 10 | 25 | 20 | 15 | 300 | 1050 | 0.49 | 0.52 | Inv. |
| 3 | 1 | 11 | 5 | 10 | 25 | 20 | 10 | 200 | 700 | 0.31 | 0.60 | Inv. |
| 4 | 1 | 11 | 5 | 10 | 25 | 20 | 16 | 320 | 1120 | 0.54 | 0.48 | Inv. |
| 5 | 1 | 11 | 5 | 10 | 25 | 20 | 20 | 400 | 900 | 0.52 | 0.42 | Inv. |
| 6 | 1 | 11 | 5 | 10 | 25 | 20 | 5 | 100 | 1000 | 0.54 | 0.68 | Inv. |
| 7 | 1 | | | | | | | | 1000 | 0.55 | 0.75 | Comp. |
| 8 | 1 | | | | | | | | 600 | 0.29 | 0.80 | Comp. |
| 9 | 1 | 11 | 5 | 10 | 25 | 20 | 10 | 200 | 800 | 0.35 | 0.85 | Comp. |
| 10 | 1 | 11 | 5 | 10 | 25 | 20 | 15 | 300 | 1050 | 0.54 | 0.39 | Comp. |
| 11 | 1 | 11 | 5 | 10 | 25 | 20 | 10 | 200 | 1200 | 0.58 | 0.68 | Comp. |

Inv.: Present invention
Comp.: Comparative example
*1: Aluminum plate,
*2: Hydrochloric acid,
*3: Nitric acid
*4: Acetic acid,
*5: Temperature,
*6: Electrolysis time
*7: Quantity of electricity
*8: Total quantity of electricity
*9: Average surface roughness
*10: Amplitude distribution curve

(Preparation of Supports for Photopolymerization Type Planographic Printing Plate Material 1-11 for a FD-YAG Laser Source (532 nm))

The photopolymerizable image formation layer coating solution was coated on the above supports 1-11 via a wire bar, and dried at 95° C. for 1.5 minutes to give the image formation layer having 1.6 g/m².

After that, the protective layer coating solution having the following composition was coated further on the image formation layer using an applicator, and dried at 75° C. for 1.5 minutes to give the protective layer having 1.7 g/m². The photopolymerizable planographic printing plate material comprising the protective layer provided on the image formation layer was prepared.

(Photopolymerizable Image Formation Layer Coating Solution)

| | | |
|---|---|---|
| Polymer binder B-1 (described below) | 40.0 | parts |
| Sensitizing dye D-1:D-2 = 1:1 (described below) | 3.0 | parts |
| Photopolymerization initiator η-cumene- | 4.0 | parts |
| (η-cyclopentadienyl)iron hexafluorophosphate | | |
| Addition polymerizable ethylenically | 40.0 | parts |
| unsaturated monomer M-3 (described before) | | |
| Addition polymerizable ethylenically unsaturated monomer | 15.0 | parts |
| NK ESTER G (polyethylene glycol dimethacrylate | | |
| produced by Shinnakamura Kagaku Co., Ltd.) | | |
| Hindered amine compound (LS-770 | 0.1 | parts |
| produced by Sankyo Co., Ltd.) | | |
| Trihaloalkyl compound E-1 (described below) | 1.0 | parts |
| Phthalocyanine pigment (MHI 454 | 4.0 | parts |
| produced by Mikuni Sikisosha) | | |
| Fluorine-containing surfactant (F 178K produced | 0.5 | parts |
| by Dainippon Ink Kagaku Kogyo Co., Ltd.) | | |
| Methyl ethyl ketone | 80 | parts |
| Cyclohexanone | 820 | parts |

(Synthesis of Polymer Binder B-1)

One hundred and twenty-five parts (1.25 mol) of methyl methacrylate, 12 parts (0.10 mol) of ethyl methacrylate, 63 parts (0.73 mol) of methacrylic acid, 240 parts of cyclohexanone, 160 parts of isopropyl alcohol, and 5 parts of α,α′-azobisisobutyro-nitrile were put in a three neck flask under nitrogen atmosphere, and reacted under nitrogen atmosphere for 6 hours at 80° C. in an oil bath. After that, 4 parts of triethylbenzylammonium chloride and 52 parts (0.73 mol) of glycidyl methacrylate were further added to the mixture, and reacted at 25° C. for 3 hours. Thus, polymer binder B-1 was obtained. The weight average molecular weight of the polymer binder B-1 was 55,000 (in terms of polystyrene), measured according to GPC.

| | |
|---|---|
| | D-1 |
| 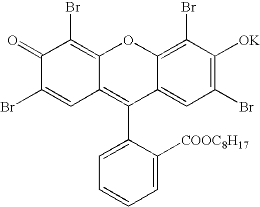 | |
| | D-2 |
| 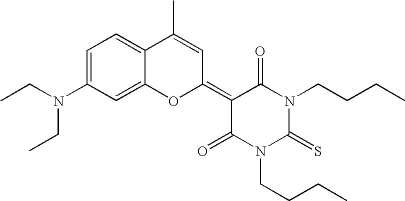 | |
| | E-1 |
| 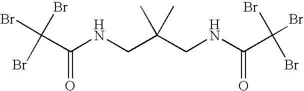 | |
| (PROTECTIVE LAYER COATING SOLUTION) | |

| | |
|---|---|
| Polyvinyl alcohol (GL-05, produced | 84 parts |
| by Nippon Gosei Kagaku Co., Ltd.) | |
| Polyvinyl pyrrolidone (K-30, produced | 15 parts |
| by ISP Japan) | |
| Surfactant (Surfinol 465, | 0.5 parts |
| produced by Nisshin Kagaku Kogyo Co., Ltd.) | |
| Water | 900 parts |

The photopolymerizable planographic printing plate material obtained above was exposed to laser light at a resolution of 2400 dpi (“dpi” means a dot number per 1 inch, i.e., 2.54 cm) and at a screen line number of 175 with 150 J/cm², employing a CTP exposure device Tigercat (produced by ECRM Co., Ltd.), in which a FD-YAG laser was installed. The image exposed to the laser light contains a solid image and a dot image with a dot area of 1 to 99%.

Subsequently, Subsequently, the exposed sample was subjected to development treatment employing a CTP automatic developing machine (PHW 23-V produced by Technigraph Co., Ltd.) to obtain planographic printing plates. Herein, the developing machine comprised a heating section, a pre-washing section for removing the protective layer before development, a development section charged with developer having the following developer composition, a washing section for removing the developer remaining on the developed sample after development, and a gumming section charged with a gumming solution (a solution obtained by diluting GW-3, produced by Mitsubishi Chemical Co., Ltd., with water by a factor of 2) for protecting the surface of the developed sample. Thus, planographic printing plates 1-11 were obtained.

The heating section was set to a surface temperature of 105° C. for 15 seconds.

Time taken from completion of exposure till to arrival at the heating section was within 30 seconds. Developer composition (aqueous solution containing the following components)

| | | |
|---|---|---|
| Potassium silicate solution (containing 26% | 40.0 | g/l |
| by weight of SiO₂ and 13.5% by weight of K₂O) | | |
| Potassium hydroxide | 4.0 | g/l |
| Ethylenediaminetetraacetic acid | 0.5 | g/l |
| Sodiumsulfo-polyoxyethylene (13) | 20.0 | g/l |
| naphthyl ether | | |

Water was added to make a 1 liter developer. PH of the developer was 12.3.

(Printing Method)

Employing the resulting planographic printing plate prepared via exposure and development, printing was carried out on a press (DAIYA1F-1 produced by Mitsubishi Jukogyo Co., Ltd.), wherein coated paper, printing ink (Soybean oil ink, “Naturalith 100” produced by Dainippon Ink Kagaku Co., Ltd.), and dampening water (SG-51, H solution produced by Tokyo Ink Co., Ltd., Concentration: 1.5%) were used.

(Dot Reproduction)

The exposure method described above was linearly corrected, and a dot image with a dot area of 1 to 99% was linearly reproduced on the printing plate.

Next, printing was carried out for 1,000 copies, and an amount of dot gain at 50% dot on the printed surface and maximum reproduction of dots at shadow portions are evaluated as a measure of dot reproduction.

The less the amount of dot gain or the larger the maximum reproduction of dots at shadow portions is, the better the dot reproduction. The results are shown in Table 2.

(Small Dot Printing Durability)

The exposure method described above was linearly corrected, and a dot image with a dot area of 1 to 99% was linearly reproduced on the printing plate. The number of printing cycles in which 5% dots have not been reproduced is evaluated as a measure of small dot printing durability. The more the cycles are, the higher the printing durability. The results are shown in Table 2.

(Printing Durable Anti-Stain Property)

Printing was carried out for 50,000 copies under the above printing condition, and stopped. Subsequently, an ink form-roller was brought into contact with a printing plate to deposit ink onto the entire printing plate. The results are shown in Table 2.

The number of printing cycles in which stain at non-image portions can entirely be removed, after printing started is evaluated as a measure of printing durable anti-stain property. The less the number of printing cycles to remove stain at non-image portions, the better the printing durable anti-stain property is.

As is apparent from Table 2, it is to be understood that planographic printing plate materials employing the support manufactured based on the present invention provide high dot reproduction, excellent small dot printing durability and excellent printing durable anti-stain property at non-image portions during printing.

TABLE 2

| | | | | | Printing | |
|---|---|---|---|---|---|---|
| | | | | | durable | |
| | | | | Small | anti-stain | |
| | | Dot reproduction | | dot | property | |
| | | | Maximum | printing | Number of | |
| | | | reproduction | durability | printing | |
| | | | of | Number of | paper | |
| Planographic | | Amount of | dots % | printing | sheets for | |
| printing | | dot gain | at shadow | paper | stain | |
| plate | Support | (%) | portions | sheets | recovery | Remarks |
| 1 | 1 | 13 | 90 | 350000 | 15 | Present |
| | | | | | | invention |
| 2 | 2 | 13 | 90 | 350000 | 20 | Present |
| | | | | | | invention |
| 3 | 3 | 14 | 90 | 350000 | 16 | Present |
| | | | | | | invention |
| 4 | 4 | 14 | 90 | 350000 | 15 | Present |
| | | | | | | invention |
| 5 | 5 | 14 | 90 | 350000 | 17 | Present |
| | | | | | | invention |
| 6 | 6 | 14 | 90 | 350000 | 18 | Present |
| | | | | | | invention |
| 7 | 7 | 16 | 85 | 250000 | 25 | Comparative |
| | | | | | | example |
| 8 | 8 | 20 | 75 | 200000 | No | Comparative |
| | | | | | recovery | example |
| 9 | 9 | 19 | 80 | 200000 | 30 | Comparative |
| | | | | | | example |
| 10 | 10 | 22 | 70 | 150000 | No | Comparative |
| | | | | | recovery | example |
| 11 | 11 | 15 | 85 | 250000 | 30 | Comparative |
| | | | | | | example |

(Preparation of Supports for Photopolymerization Type Planographic Printing Plate Material 12-22 for a Violet Source)

The photopolymerizable image formation layer coating solution was coated on the above supports 1-11 via a wire bar, and dried at 95° C. for 1.5 minutes to give the image formation layer having 1.9 g/m².

After that, the protective layer coating solution having the following composition was coated further on the image formation layer using an applicator, and dried at 75° C. for 1.5 minutes to give the protective layer having 1.7 g/m². The photopolymerizable planographic printing plate material comprising the protective layer provided on the image formation layer was prepared.

(Photopolymerizable Image Formation Layer Coating Solution)

| | |
|---|---|
| Polymer binder B-1 (described before) | 40.0 parts |
| Photopolymerization initiator η-cumene- | 3.0 parts |
| (η-cyclopentadienyl)iron hexafluorophosphate | |
| Sensitizing dye D-3/D-4 = 1/1 (described below) | 4.0 parts |
| Addition polymerizable ethylenically | |
| unsaturated monomer M-3 (described before) | 40.0 parts |
| Addition polymerizable ethylenically unsaturated monomer | 7.0 parts |
| NK ESTER G (polyethylene glycol dimethacrylate | |
| produced by Shinnakamura Kagaku Co., Ltd.) | |
| Compound containing a cationically polymerizable | 8.0 parts |
| group C-1 (described below) | |
| Hindered amine compound (LS-770 | 0.1 parts |
| produced by Sankyo Co., Ltd.) | |
| Trihaloalkyl compound E-1 (described before) | 5.0 parts |
| Phthalocyanine pigment (MHI 454 | 7.0 parts |
| produced by Mikuni Sikisosha) | |
| Fluorine-containing surfactant (F 178K produced | 0.5 parts |
| by Dainippon Ink Kagaku Kogyo Co., Ltd.) | |
| Methyl ethyl ketone | 80 parts |
| Cyclohexanone | 820 parts |

D-3

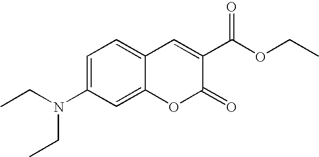

D-4

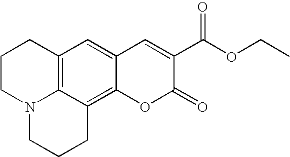

C-1

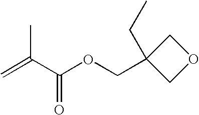

(Image Formation)

The photopolymerizable planographic printing plate material obtained above was exposed to laser light at a resolution of 2400 dpi (“dpi” means a dot number per 1 inch, i.e., 2.54 cm) and at a screen line number of 175 with 50 μJ/cm², employing a plate setter Tigercat (produced by ECRM Co., Ltd.), in which a 408 nm laser with an output power of 30 mW was installed. The image exposed to the laser light contains a solid image and a dot image with a dot area of 1 to 99%.

Subsequently, the exposed sample was subjected to development treatment employing a CTP automatic developing machine (PHW 23-V produced by Technigraph Co., Ltd.) to obtain a planographic printing plate. Herein, the developing machine comprised a heating section, a pre-washing section for removing the protective layer before development, a development section charged with developer having the aforesaid developer composition, a washing section for removing the developer remaining on the developed sample after development, and a gumming section charged with a gumming solution (a solution obtained by diluting GW-3, produced by Mitsubishi Chemical Co., Ltd., with water by a factor of 2) for protecting the surface of the developed sample. Thus, planographic printing plates 12-22 were obtained.

Herein, heating was carried out at a surface temperature of 105° C. for 15 seconds. Time taken from completion of exposure till to arrival at the heating section was within 30 seconds.

(Printing Method, Dot Reproduction, Small Dot Printing Durability, and Printing Durable Anti-Stain Property))

Evaluations were made according to the same method as described before. The results are shown in Table 3.

As is apparent from Table 3, it is to be understood that planographic printing plate materials employing the support manufactured based on the present invention provide high dot reproduction, excellent small dot printing durability and excellent printing durable anti-stain property at non-image portions during printing.

TABLE 3

| | | | | | Printing | |
|---|---|---|---|---|---|---|
| | | | | | durable | |
| | | | | Small | anti-stain | |
| | | Dot reproduction | | dot | property | |
| | | | Maximum | printing | Number of | |
| | | | reproduction | durability | printing | |
| | | | of | Number of | paper | |
| Planographic | | Amount of | dots % | printing | sheets for | |
| printing | | dot gain | at shadow | paper | stain | |
| plate | Support | (%) | portions | sheets | recovery | Remarks |
| 12 | 1 | 13 | 85 | 300000 | 15 | Present |
| | | | | | | invention |
| 13 | 2 | 13 | 85 | 250000 | 20 | Present |
| | | | | | | invention |
| 14 | 3 | 14 | 85 | 300000 | 16 | Present |
| | | | | | | invention |
| 15 | 4 | 14 | 85 | 300000 | 15 | Present |
| | | | | | | invention |
| 16 | 5 | 14 | 85 | 300000 | 17 | Present |
| | | | | | | invention |
| 17 | 6 | 14 | 85 | 300000 | 18 | Present |
| | | | | | | invention |
| 18 | 7 | 16 | 80 | 200000 | 25 | Comparative |
| | | | | | | example |
| 19 | 8 | 20 | 70 | 150000 | No | Comparative |
| | | | | | recovery | example |
| 20 | 9 | 19 | 75 | 150000 | 30 | Comparative |
| | | | | | | example |
| 21 | 10 | 22 | 65 | 100000 | No | Comparative |
| | | | | | recovery | example |
| 22 | 11 | 15 | 80 | 200000 | 30 | Comparative |
| | | | | | | example |

(Preparation of Supports for Photopolymerization Type Planographic Printing Plate Material 23-33 for an Infrared Laser Source (830 nm))

The image formation layer coating solution having the following composition was coated on the aforesaid supports 1-11 via a wire bar, and dried at 95° C. for 1.5 minutes to give the image formation layer having 1.5 g/m². After that, the protective layer coating solution with the aforesaid composition was further coated on the image formation layer using an applicator, and dried at 75° C. for 1.5 minutes to give the protective layer with 1.7 g/m². Thus, planographic printing plate materials having the protective layer on the image formation layer were prepared.

(Image Formation Layer Coating Solution)

| | |
|---|---|
| Polymer binder B-1 (describe before) | 40.0 parts |
| Infrared absorbing dye D-5 (described below) | 2.5 parts |
| N-Phenylglycine benzyl ester | 4.0 parts |
| Addition polymerizable ethylenically | |
| unsaturated monomer M-3 (described before) | 40.0 parts |
| Addition polymerizable ethylenically unsaturated monomer | 7.0 parts |
| NK ESTER G (polyethylene glycol dimethacrylate, | |
| produced by Shinnakamura Kagaku Co., Ltd.) | |
| Compound containing a cationically polymerizable | 8.0 parts |
| group C-1 (described before) | |
| Hindered amine compound | 0.1 parts |
| (LS-770 produced by Sankyo Co., Ltd.) | |
| Trihaloalkyl compound E-1 (described before) | 5.0 parts |
| Phthalocyanine pigment | 7.0 parts |
| (MHI 454 produced by Mikuni Sikisosha) | |
| Fluorine-contained surfactant (F-178K | 0.5 parts |
| produced by Dainippon Ink Kagaku Kogyo Co., Ltd.) | |
| Methyl ethyl ketone | 80 parts |
| Cyclohexanone | 820 parts |

D-5

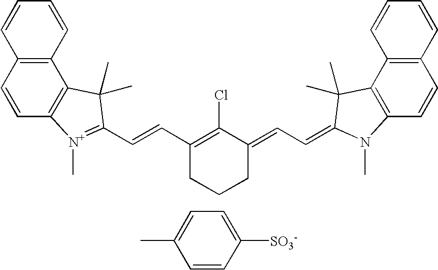

(Image Formation)

Employing a plate setter Trend Setter 3244 (produced by Creo Co., Ltd.), in which a 830 nm laser was installed, the planographic printing plate material obtained above was exposed to laser light at a resolving degree of 2400 dpi and at a screen number of 175 with 150 mJ/cm² to obtain an image. The image pattern used for the exposure comprised a solid image and a dot image with a dot area of 1 to 99%.

Subsequently, the exposed sample was subjected to development treatment employing a CTP automatic developing machine (PHW 23-V produced by Technigraph Co., Ltd.) to obtain a planographic printing plate. Herein, the developing machine comprised a heating section, a pre-washing section for removing the protective layer before development, a development section charged with developer having the aforesaid developer composition, a washing section for removing the developer remaining on the developed sample after development, and a gumming section charged with a gumming solution (a solution obtained by diluting GW-3, produced by Mitsubishi Chemical Co., Ltd., with water by a factor of 2) for protecting the surface of the developed sample. Thus, planographic printing plates 23-33 were obtained.

Herein, heating was carried out at a surface temperature of 115° C. for 15 seconds. Time taken from completion of exposure till to arrival at the heating section was within 30 seconds.

(Printing Method, Dot Reproduction, Small Dot Printing Durability, and Printing Durable Anti-Stain Property))

Evaluations were made according to the same method as described before. The results are shown in Table 4.

As is apparent from Table 4, it is to be understood that planographic printing plate materials employing the support manufactured based on the present invention provide high dot reproduction, excellent small dot printing durability and excellent printing durable anti-stain property at non-image portions during printing.

TABLE 4

| | | | | | Printing | |
|---|---|---|---|---|---|---|
| | | | | | durable | |
| | | | | Small | anti-stain | |
| | | Dot reproduction | | dot | property | |
| | | | Maximum | printing | Number of | |
| | | | reproduction | durability | printing | |
| | | | of | Number of | paper | |
| Planographic | | Amount of | dots % | printing | sheets for | |
| printing | | dot gain | at shadow | paper | stain | |
| plate | Support | (%) | portions | sheets | recovery | Remarks |
| 23 | 1 | 13 | 90 | 250000 | 15 | Present |
| | | | | | | invention |
| 24 | 2 | 13 | 90 | 200000 | 20 | Present |
| | | | | | | invention |
| 25 | 3 | 14 | 90 | 250000 | 16 | Present |
| | | | | | | invention |
| 26 | 4 | 14 | 90 | 250000 | 15 | Present |
| | | | | | | invention |
| 27 | 5 | 14 | 90 | 250000 | 17 | Present |
| | | | | | | invention |
| 28 | 6 | 14 | 90 | 250000 | 18 | Present |
| | | | | | | invention |
| 29 | 7 | 16 | 85 | 150000 | 25 | Comparative |
| | | | | | | example |
| 30 | 8 | 20 | 75 | 100000 | No | Comparative |
| | | | | | recovery | example |
| 31 | 9 | 19 | 80 | 100000 | 30 | Comparative |
| | | | | | | example |
| 32 | 10 | 22 | 70 | 50000 | No | Comparative |
| | | | | | recovery | example |
| 33 | 11 | 15 | 85 | 150000 | 30 | Comparative |
| | | | | | | example |

(Preparation of Supports for Positive Working Planographic Printing Plate Material 34-44 for an Infrared Laser Source (830 nm))

The image formation layer coating solution having the following composition was coated on the aforesaid supports 1-11 via a wire bar, and dried at 95° C. for 1.5 minutes to give the image formation layer having 1.5 g/m². Thus, the planographic printing plate materials were prepared.

(Image Formation Layer Coating Solution)

| | | |
|---|---|---|
| Novolac resin (m-cresol-p-cresol (60/40) | 1.0 | part |
| novolac resin containing having an unreacted cresol | | |
| content of 0.5% by weight and a weight average | | |
| molecular weight of 7,000) | | |
| Infrared absorbing dye D-5 (described before) | 0.1 | parts |
| Tetrahydrophthalic anhydride | 0.05 | parts |
| p-Toluene sulfonic acid | 0.002 | parts |
| Ethyl violet in which Cl⁻ was substituted | 0.02 | parts |
| with 6-hydroxy-β-naphthalene sulfonate ion | | |
| Fluorine-contained surfactant (F-178K produced by | 0.5 | parts |
| Dainippon Ink Kagaku Kogyo Co., Ltd.) | | |
| Methyl ethyl ketone | 12 | parts |

(Image Formation)

Employing a plate setter Trend Setter 3244 (produced by Creo Co., Ltd.), in which a 830 nm laser was installed, the planographic printing plate material obtained above was exposed to laser light at a resolving degree of 2400 dpi and at a screen number of 175 with 150 mJ/cm² to obtain an image. The image pattern used for the exposure comprised a solid image and a dot image with a dot area of 1 to 99%.

Subsequently, the exposed sample was subjected to development treatment employing a CTP automatic developing machine (PHW 23-V produced by Technigraph Co., Ltd.) to obtain a planographic printing plate. Herein, the developing machine comprised a heating section, a pre-washing section for removing the protective layer before development, a development section charged with developer having the aforesaid developer composition, a washing section for removing the developer remaining on the developed sample after development, and a gumming section charged with a gumming solution (a solution obtained by diluting GW-3, produced by Mitsubishi Chemical Co., Ltd., with water by a factor of 2) for protecting the surface of the developed sample. Thus, planographic printing plates 34-44 were obtained.

Herein, the heating section switched off, heating was not carried out, and washing water for removing a protective layer was not supplied to the pre-washing section. Time taken from completion of exposure till to arrival at the preheating section was within 30 seconds.

Developer Composition (Aqueous Solution Containing the Following Composition)

| | | |
|---|---|---|
| Potassium salt of nonreducing sugar | 50 | g/l |
| (formed from D-sorbit and K₂O) | | |
| Orfin AK-02 (produced by Nissin Kagaku Co., Ltd.) | 0.15 | g/l |
| C₁₂H₂₅N(CH₂CH₂COONa)₂ | 1.0 | g/l |

Water was added to make a 1 liter developer.

(Printing Method, Dot Reproduction, Small Dot Printing Durability, and Printing Durable Anti-Stain Property))

Evaluations were made according to the same method as described before. The results are shown in Table 5.

As is apparent from Table 5, it is to be understood that planographic printing plate materials employing the support manufactured based on the present invention provide high dot reproduction, excellent small dot printing durability and excellent printing durable anti-stain property at non-image portions during printing.

TABLE 5

| | | | | | Printing | |
|---|---|---|---|---|---|---|
| | | | | | durable | |
| | | | | Small | anti-stain | |
| | | Dot reproduction | | dot | property | |
| | | | Maximum | printing | Number of | |
| | | | reproduction | durability | printing | |
| | | | of | Number of | paper | |
| Planographic | | Amount of | dots % | printing | sheets for | |
| printing | | dot gain | at shadow | paper | stain | |
| plate | Support | (%) | portions | sheets | recovery | Remarks |
| 34 | 1 | 13 | 95 | 200000 | 17 | Present |
| | | | | | | invention |
| 35 | 2 | 13 | 95 | 150000 | 22 | Present |
| | | | | | | invention |
| 36 | 3 | 14 | 95 | 200000 | 18 | Present |
| | | | | | | invention |
| 37 | 4 | 14 | 95 | 200000 | 17 | Present |
| | | | | | | invention |
| 38 | 5 | 14 | 95 | 200000 | 19 | Present |
| | | | | | | invention |
| 39 | 6 | 14 | 95 | 200000 | 20 | Present |
| | | | | | | invention |
| 40 | 7 | 16 | 90 | 100000 | 27 | Comparative |
| | | | | | | example |
| 41 | 8 | 20 | 80 | 50000 | No | Comparative |
| | | | | | recovery | example |
| 42 | 9 | 19 | 85 | 50000 | 32 | Comparative |
| | | | | | | example |
| 43 | 10 | 22 | 75 | 25000 | No | Comparative |
| | | | | | recovery | example |
| 44 | 11 | 15 | 90 | 100000 | 32 | Comparative |
| | | | | | | example |

(Preparation of Supports for Positive Working Planographic Printing Plate Material 45-55 for an Infrared Laser Source (830 nm))

The following materials were sufficiently mixed while stirring, employing a homogenizer, and filtered to obtain a hydrophilic layer coating solution with a solid content of 15% by weight.

Then, the hydrophilic layer coating solution was coated on the surface of the aforesaid supports 1-11 with a wire bar to obtain a hydrophilic layer with 2.0 g/m², dried at 100° C. for 3 minutes, and further subjected to aging at 60° C. for 24 hours.

(Hydrophilic Layer Coating Solution)

| | | |
|---|---|---|
| Metal oxide particles having a light-to-heat | 12.50 | parts |
| conversion capability, Black iron oxide | | |
| particles ABL-207 (produced by Titan Kogyo K.K., | | |
| octahedral form, average particle diameter: | | |
| 0.2 μm, specific surface area: 6.7 m²/g, | | |
| Hc: 9.95 kA/m, σs: 85.7 Am²/kg, σr/σs: 0.112) | | |
| Colloidal silica (alkali type): Snowtex XS | 60.62 | parts |
| (solid content: 20% by weight, produced by | | |
| Nissan Kagaku Co., Ltd.) | | |
| Aqueous 10% by weight sodium phosphate | 1.13 | parts |
| dodecahydrate solution (Reagent produced | | |
| by Kanto Kagaku Co., Ltd.) | | |
| Aqueous 10% by weight solution of water-soluble | 2.50 | parts |
| chitosan Flownack S (produced by Kyowa Technos | | |
| Co., Ltd.) | | |
| Aqueous 1% by weight solution of Surfactant | 1.25 | parts |
| Surfinol 465 (produced by Air Products Co., Ltd.) | | |
| Pure water | 22.00 | parts |

Subsequently, the following image formation layer coating solution was coated on the hydrophilic layer, employing a wire bar, dried, and further subjected to aging. Thus, the planographic printing plate materials were prepared.

Image formation layer: dry thickness of 1.50 g/m², drying at 55° C. for 3 minutes, and aging at 40° C. for 24 hours.

(Image Formation Layer Coating Solution)

| | | |
|---|---|---|
| Aqueous polyurethane Takelac W-615 (solid content: | 17.1 | parts |
| 35% by weight, produced by Mitsui Takeda | | |
| Chemical Co., Ltd.) | | |
| Aqueous block isocyanate Takenate XWB-72-N67 | 7.1 | parts |
| (solid content: 45% by weight, produced by | | |
| Mitsui Takeda Chemical Co., Ltd.) | | |
| Aqueous solution (solid content: 10% by weight) | 5.0 | parts |
| of sodium acrylate Aqualic DL522 (produced by | | |
| Nippon Shokubai Co., Ltd.) | | |
| Ethanol solution (solid content: 1% by weight) | 30.0 | parts |
| of light-to-heat conversion dye ADS 830AT | | |
| (produced by American Dye Source Co., Ltd.) | | |
| Pure water | 40.8 | parts |

Employing a plate setter Trend Setter 3244 (produced by Creo Co., Ltd.), in which a 830 nm laser was installed, the planographic printing plate material obtained above was exposed to laser light at a resolving degree of 2400 dpi and at a screen number of 175 with 220 mJ/cm² to obtain an image, and planographic printing plates 45-55 were prepared. The image pattern used for the exposure comprised a solid image and a dot image with a dot area of 1 to 99%.

(Printing Method)

After exposure, printing was carried out on a press (DAIYA1F-1 produced by Mitsubishi Jukogyo Co., Ltd.) employing the exposed printing plate sample, wherein a coat paper, printing ink (soybean oil-based ink “Naturalist 100” produced by Dainippon Ink Kagaku Kogyo Co., Ltd.), and dampening water (SG-51, H solution produced by Tokyo Ink Co., Ltd., Concentration: 1.5%) were used.

(Printing Method, Dot Reproduction, Small Dot Printing Durability, and Printing Durable Anti-Stain Property))

Evaluations were made according to the same method as described before.

The printing durable anti-stain property was evaluated after 10,000 copies were printed. The results are shown in Table 6.

As is apparent from Table 6, it is to be understood that planographic printing plate materials employing the support manufactured based on the present invention provide high dot reproduction, excellent small dot printing durability and excellent printing durable anti-stain property at non-image portions during printing.

TABLE 6

| | | | | | Printing | |
|---|---|---|---|---|---|---|
| | | | | | durable | |
| | | | | Small | anti-stain | |
| | | Dot reproduction | | dot | property | |
| | | | Maximum | printing | Number of | |
| | | | reproduction | durability | printing | |
| | | | of | Number of | paper | |
| Planographic | | Amount of | dots % | printing | sheets for | |
| printing | | dot gain | at shadow | paper | stain | |
| plate | Support | (%) | portions | sheets | recovery | Remarks |
| 45 | 1 | 16 | 85 | 150000 | 20 | Present |
| | | | | | | invention |
| 46 | 2 | 16 | 85 | 100000 | 25 | Present |
| | | | | | | invention |
| 47 | 3 | 17 | 85 | 150000 | 21 | Present |
| | | | | | | invention |
| 48 | 4 | 17 | 85 | 150000 | 20 | Present |
| | | | | | | invention |
| 49 | 5 | 17 | 85 | 150000 | 22 | Present |
| | | | | | | invention |
| 50 | 6 | 17 | 85 | 150000 | 23 | Present |
| | | | | | | invention |
| 51 | 7 | 19 | 80 | 50000 | 30 | Comparative |
| | | | | | | example |
| 52 | 8 | 23 | 70 | 25000 | 50 | Comparative |
| | | | | | | example |
| 53 | 9 | 22 | 75 | 25000 | 35 | Comparative |
| | | | | | | example |
| 54 | 10 | 25 | 65 | 20000 | 50 | Comparative |
| | | | | | | example |
| 55 | 11 | 18 | 80 | 50000 | 35 | Comparative |
| | | | | | | example |

### EFFECT OF THE INVENTION

A planographic printing plate material exhibiting excellent dot reproduction, small dot printing durability and anti-stain property at non-image portions, and a support for the planographic printing plate material are provided via the aforesaid structures of the present invention. Particularly provided are the planographic printing plate material exhibiting excellent dot reproduction and printing durability, and a support for the planographic printing plate material, when printing is carried out employing ink containing no VOC (volatile organic compound).

What is claimed is:

1. A support for a planographic printing plate material comprising a surface roughened via electrolytic surface-roughening treatment and anodization treatment conducted to one surface of an aluminum plate,
wherein a) average surface roughness (Ra) of the roughened surface is 0.30-0.55 μm, and b) the roughened surface comprises a surface profile in which a ratio of Xa/Xb is 0.40-0.70, where Xa is a width expanding to a shallow region side and Xb is a width expanding to a deep region side at the position reaching peak depth in amplitude frequency.

2. The support for a planographic printing plate material of claim 1,
wherein the aluminum plate further contains Mg of 0.1-0.4% by weight.

3. A planographic printing plate material comprising the support of claim 1, and an image formation layer provided on the support.

4. The planographic printing plate material of claim 3,
wherein the image formation layer is a thermosensitive image formation layer.

5. The planographic printing plate material of claim 3,
wherein the image formation layer is a photopolymerizable image formation layer.

6. The planographic printing plate material of claim 3,
wherein the image formation layer is a layer capable of being developed during printing.
